(19) United States
(12) Patent Application Publication
(10) Pub. No.: US 2007/0021145 A1
(43) Pub. Date: Jan. 25, 2007

(54) Methods and systems for enabling the injection of sounds into communications

(76) Inventor: Bin Wai Lam, La Mesa, CA (US)

Correspondence Address: JLB Consulting;c/o Intellevate, P.O. Box 52050, Minneapolis, MN, 55402, US

(21) Appl. No.: 11/455,588

(22) Filed: Jun. 19, 2006

Related U.S. Application Data
(60) Provisional application No. 60/692,102, filed on Jun. 20, 2005.

(51) Int. Cl. H04M 1/00

(52) U.S. Cl. 455/556.1

(57) ABSTRACT

Methods and systems enable the injection of sound effects, for example professional voices, music, special effects, etc. into electronic communications, for example mobile telephone conversations, land line telephone conversations, voice over Internet protocol conversations, etc. In various disclosed embodiments of the invention, the sound injection occurs through a simplified process, each sound effect being classified both by category and specific sound. In different embodiments, a sound effect is selected through the selection first of a category followed by a specific sound, or by the direct selection of a specific sound from within a category.

### CROSS REFERENCE TO RELATED APPLICATIONS

The present invention claims priority to provisional U.S. patent application Ser. No. 60/692,102 filed Jun. 20, 2005.

### FIELD OF THE INVENTION

The present invention relates generally to electronic communications and more particularly to methods and systems for injecting sound effects into electronic communications.

### BACKGROUND OF THE INVENTION

Telephone was invented more than a century ago and, as of November 2002, telephone service has reached 95.3% penetration in the United States (accordingly to Federal Communications Commission (FCC)). Aside from telephone usage, mobile wireless phone subscribers reach more than 150 million in the U.S. alone, in 2004.

Over the last few decades, telephone has many innovations in usages and features. Technological advances from land wired phones to cordless phones to cellular phones. Features like conference call, redial, intercom, speaker phone, holding musical, digital answering, preset quick dialer, special ringers, and many others. More astonishing, mobile phone manufactures and carriers have added new features and functionalities to their phones and services by leaps and bound. For example, mobile phone users can now take and email photos, personalize their ringer and ringbacks, play games, check weather and traffic, and listen to music and news clips.

People have been using telephones to keep in touch and for casual conversations for many decades. Conversations between friends, lovers, and family can be ranged from a five or ten minutes talk to hours of phone chatting. A conversation is only a conversation. Interesting or not is all depends on both parties and the topic of discussions. Basically that's it.

Unless you are a comedian, foley artist, or an animation film voice-over talent, it's a challenge to create special sound effects just using your voice and/or any available materials.

Several devices are known to the inventor which purport to facilitate the injection of audible sounds into an electronic communication. Each suffers significant shortcomings.

FIG. 2A (prior art) shows the WiseCracks EFX Fone 200. It is a typical land-wired telephone but with eight fixed sound effects buttons 210 integrated to the phone pad. During a phone conversation, user may press any of those eight buttons to inject sound effects associated to the button to the conversation for the other party on the line to hear. The use of a limited number of hard wired sound effect buttons has obvious drawbacks and limitations.

A San Francisco-based firm, PhoneBites, has marketed a Razz Headset 202 and a downloadable Razz software 300 for several models of Nokia mobile phones, as shown on FIGS. 2B and 3A-C, respectively. The Razz Headset 202 is basically a headset for telephone. It is integrated onto a common headset for mobile phone, which comes with standard microphone 203, single speaker 204, and plug 205 to the phone. The headset included an in-line mechanism that consists of ten fixed, prerecorded sound bites. Users turn scrolling wheel to one of the ten sound bites they desire then press the wheel to inject the sound onto the voice path of the phone. One of the disadvantages is that users cannot download or choose the sound clips they desire other than the ten fixed sound clips. Another disadvantage, with a scrolling wheel, it would cause a long delay to activate a sound bite when the product starts to offer a growing number of sound bites. Worse yet, it is impossible to provide hundreds of sound clips with the scrolling wheel without the cumbersome and long hold up for selecting the “appropriate” sound bites to express and convey one's thoughts. This is also true to the attempt made by the WiseCracks EFX Fone 200, shown on FIG. 2A, that has eight fixed sound effects buttons 201 on the telephone where adding more or changing the existing sound effects is not possible.

FIG. 2B (prior art) shows Phonebite's RAZZ Headset 250. It is basically a hands-free headset with an integrated in-line mechanism. Like all standard headsets, it is equipped with a microphone 270, single speaker earpiece 275, and a 2.5 mm plug 280 for phones. The user needs to rotate the scrolling wheel 265 to locate the sound effects desired then presses the front of the wheel (which functions as a PLAY button 260) to trigger the sound, in turn, it sends audio signals to the voice path of the phone, for the other party to hear. A user may not replace or install new sound clips to the device nor can he or she can their own message or sound to use as a sound clip. When the user is bored with the ten sound effects, the device does not serve much of a value to the user anymore.

FIGS. 3A-3C (prior art) shows the graphical user interface of Phonebite's RAZZ software 300 for several of the Nokia mobile phones that are running Symbian OS (operating system). Users may purchase and download packages of sound clips. Each package consists of a menu 310 of ten audio clips with a corresponding numeric key assigned to each sound file. All ten sound clips 310 under the same package (for example, Baby) generally are related to the same theme. Should a user want to access a sound clip in a different theme (for instance, Hello Kitty), they need to press OPTIONS 320 and navigate to “Open Razz 335” on the OPTION menu window 330—then press SELECT 325 to open the folder that contains all the available theme packages. Upon selecting the highlighted item, a new window 340 opens up which contains the theme packages that the user owns. Again, the user will need to navigate to the desired item, in this example, “HelloKitty 345,” before making the selection. After selecting the desired theme package, the user is now presented with another set of ten sound bites for use. Should the user want to select another sound clip from another theme package, he will need to repeat the routine again. This method and graphical user interface is not optimal, even cumbersome, when the need to act or react on a phone conversation is instantaneous. This Razz user interface works well if the user only needs ten sound bites, it may even work with fifteen or twenty sound files. However, as the user demands or accumulates more sound clips to be ready and available at all times, then this method and user interface is not ideal nor is it an optimal solution. The inability to access a larger library of sound clips or the desired sound effects instantly would only cause a long delay, perhaps frustration, in phone conversations—therefore defeating the purpose of using sound effects to enhance phone conversations.

The Razz software 300 is an improvement over its headset 202, but still is not suitable for quick and easy injection of a larger library of sound clips. As shown on FIGS. 3A-C, the Razz application and user interface are only capable of offering a set of ten sound bites 301 at any given time. User uses the keypad 101, with button zero to nine, on the mobile phone to inject a sound bite into the conversation. If the user wants a different sound clip other than the ten clips 301 shown on the menu, they need to perform a couple of button entries to open the directory 302 within the software and a few more key strokes to locate a different theme package 303 in order to have access to different sound clips. And if the user wants to use a sound clip on a different theme package to convey their point, they need to go through the same or a more complicated routine. This graphical user interface is not efficient, it is even cumbersome, especially if users have a larger library or theme. Worse yet, this is not a realistic and effective method to inject sound effects into phone conversations where instantaneous reaction to the chatter's thought is required. They may try to offer more than ten sound clips per theme package, but it is believed that such a unsophisticated user interface and methodology will only frustrate the user and take the joy, the fun and the creativity out of the conversations.

The present inventor has determined that what is needed is an optimal method and user interface that provide for a user friendly and efficient way of injecting audio clips and sound effects, especially with a larger and a more complex library of sound files, into phone conversations.

### SUMMARY OF THE INVENTION

This invention relates generally to portable devices such as a mobile phone, multimedia asset player, and the alike. More specifically, the invention describes methods and systems including graphical user interface for use in portable devices suitable for providing any number and kind of user supplied inputs. Furthermore, it is related to audio playback on mobile phone and other portable devices, particularly allowing users to inject audio clips and sound effects to their phone conversations or messages, and more particularly to methods which help users to inject sound clips and sound effects to phone conversations more quickly and easily—without delaying the “moment” of thoughts or interrupting the conversation or voice recording.

Provided herein is an invention that can enhance a conversation. For instance, press a key(s) that is destined for an “applause” sound when making a compliment to a friend's great work or congratulate him on his business success. Or answer the phone with Bugs Bunny's favorite line “What's up doc?” or with Lionel Richie's song clip “Hello . . . Is it me you're looking for?” You might activate an audio clip with Arnold Schwarzenegger's “I will be back . . . ” after asking the other party to hold while you pick up another line. All different kinds of audio clips and special sound effects can be used simply by pressing a button to make a phone conversation more fun and lively.

### BRIEF DESCRIPTION OF THE DRAWINGS

The invention will be better understood by reference to the following description taken in conjunction with the accompanying drawings.

FIG. 1 is a front view of a typical mobile phone.

FIG. 2A (prior art) is a perspective view, including an enlarged portion, of a land-wired phone with sound effects buttons.

FIG. 2B (prior art) is a front view of a Phonebites' Razz Headset, with and without wired accessories.

FIGS. 3A-3C (prior art) shows a graphical user interface illustrating Phonebite's Razz software and it's user interface.

FIG. 4 is a block diagram illustrating a hierarchically ordered interface corresponding to stored sound files in accordance with an embodiment of the invention.

FIG. 5 shows a flowchart illustrating a particular process for selecting a particular one of a group of stored sound clips in accordance with an embodiment of the invention.

FIGS. 6A-6C illustrate various exemplary user interfaces consistent with selection and play of a sound clip in accordance with one embodiment of the invention.

FIG. 6D illustrates exemplary user interfaces consistent with selection and play of a sound clip in accordance with another embodiment of the invention.

FIGS. 7A-7B together show graphical user interfaces (7A) and user phone operation (7B) illustrating one method of injecting a sound clip into phone conversations.

FIG. 8 is a chart illustrating exemplary button functionalities for portable devices and the like.

FIGS. 9A-9C are charts showing samples of abbreviated identifiers (9A) and a process (9B, C) for using another method to inject sound clips into phone conversations.

FIGS. 10A-10J show exemplary graphical user interfaces of MENUs and sub-menus in accordance with one embodiment of the invention.

### DETAILED DESCRIPTION OF THE INVENTION

The present invention provides methods and systems, including graphical user interfaces, for injecting sound clips and special sound effects onto phone conversations quickly and easily. In certain embodiments, injecting sound clips can be performed quickly and easily, for example in two quick easy steps while other embodiments require only require one swift step, thus allowing the user to convey or express his thoughts with sound effects or the “appropriate” audio clip without delaying the “moment” of thoughts or reactions.

As used herein, terms such as “immediately,” “instantaneously” and “instantly” are used to describe a typical user's perception of the speed with which a described action occurs.

Features, benefits and advantages of the invention include, in some embodiments:
a product young consumers will like to use
a product that provides amusement
a product for people to inject sound effects to their phone conversations or voice mail or greeting messages quickly and easily
methods and user interfaces that won't interfere their phone conversations or delay their intended expressions
a product into which users can incorporate his or her choice of sound effects according to the “moment” of thought and conversation
a product that has a commercial value by being amusing, entertaining, unusual and capable of producing a surprise effect, and
a product that enhance users' phone conversation with fun and creative usages.

Further features, benefits and advantages of the invention include, in some embodiments:
methodologies that offer optimal usability and easy to understand graphical user interface.
versatility.
allowing users to inject a sound clip into phone conversations much quicker and easier, thus without having to delay the need for instantaneous expression.
allowing users to select and trigger (inject) an audio clip in two quick easy steps while the third method only requires one swift step.
allowing users to record his or her own voice to be used as a sound clip.
in addition to mobile phones and land-wired telephones, with an adapter device (not shown), the inventive methods and user interfaces work with most other media-playback devices, handheld computers, notebook and desktop computers, and other portable devices.
sound clips and play lists (song lists) as well as interface and menus can be customized, categorized, grouped, rearranged, renamed, deleted, or added.
sound bites can be triggered (injected to phone conversation) in more than one method.
sound bites can be triggered (injected) by keying in abbreviated identifiers which means a user can simply press the first 3-letters of the sound clip name or the 3-letter abbreviated identifier of the associated sound file.
sound clips can be played (injected) by utilizing speech recognition.
sound bites can be played (injected) automatically based on chatters' tones and mood of voices of the user or all parties on the phone conversation.
sound files can be injected automatically based on key word(s) and phrase(s) spoken by the user or all parties on the phone conversation.
in addition to injecting audio clips, a user may alter his voice with our sound effects features such as, for example, robotic, lower or increase voice pitch, echoing, cartoon-ize, or other voice manipulation.
methodologies and graphical user interfaces described herein work on software that resided (installed) on the mobile phone and other portable devices as well as on the phone company's central switch with the server-based application.
methodologies and graphical user interfaces described herein can be incorporated in other portable devices and land-wired telephones other than mobile phones.

The present invention provides means by which audio clips and sound effects can be added to phone conversations, e.g., a person can press a button or buttons to create a dog barking or footstep noises. Other features include, but are not limited to, sound effects like an echo effect or cartoonized user's voices. The present invention offers the benefit of creating a more fun, creative, and vivid conversations for phone users.

The invention described herein further provides systems, methodologies and user interfaces that provides for a user friendly and efficient way to inject sound effects into phone conversations, messages, or voice recordings. In accordance with the invention, I provide multiple different methodologies and devise a graphical user interface for allowing users to quickly and easily play (inject) audio clips and special sound effects to the voice path of the phone, in turn, into their phone conversations. Examples include:
Example: A quick and easy two-step process with key entry to trigger (inject) a sound clip (with 2-level interface: Sound Categories & Sound Files interfaces)
Example: A fast one-step method of sound clip injection with input of 3-letter abbreviated identifiers that are associated to particular sound files (3 key-strokes)
Example: A simple two-step process with speech recognition to trigger a sound clip (depress a button and speak the name of the desired sound clip)

In one embodiment, a method of assisting user interaction with a mobile phone and portable media devices by way of a two-ordered user interface is described. A first order user interface having a list or table of user selectable items is displayed and a user selection of one of the user selectable items is received. Based upon the user selection, automatically transitioning to and instantly displaying a second order user interface which reveal a list (collection) of sound effects (sound files).

In a mobile phone, portable device, and the like, a method of selecting and injecting a sound clip from a group of audio files stored therein is described. A first order user interface (also referred to as the SOUND CATEGORIES interface) is displayed on the device having a first number of items each of which is associated with a particular grouping of the stored audio files. A selection of one of the first number of items is received and based upon the selected one of the first number of items, automatically transitioning to and displaying a second order user interface (referred to as SOUND FILES interface) is displayed on the device that includes a second number of items each of which is associated with the selected item from the first order interface. Upon selecting one of the user-selectable sound files, an instant audio playback will be executed and can be heard from both the user (caller) and the party or parties on the line (phone conversation). In addition to user input device, user can also trigger a particular item by pressing numeric key(s) which correspond to the desired item. In most cases, with minimal keystrokes such as three keystrokes, a user is able to trigger a desired sound clip within a particular sound category of choice. And only one or two additional keystrokes are necessary to select another clip within the same category.

In another embodiment of the invention, a user may activate the speech recognition function by simply pressing and holding the designated button. With the button depressed, speaking the pre-assigned keyword or phrase of the sound clip name then releasing the depressed button, the desired sound clip will automatically and substantially instantly be played and injected to the voice path where it's audible to all parties on the phone conversation.

In yet another embodiment of the invention, the user may opt to utilize the fast one-step abbreviated identifier method to inject sound effects into phone conversations with a mobile phone and the like. Abbreviated identifiers are user customizable pre-assigned 3-letter identifier (I.D.s) that are associated with a specific sound clip or group of sound clips. Pressing any pre-assigned 3-letter I.D. consecutively will automatically and instantly play and inject the desired sound clip into the phone conversation.

In addition to these three highly optimized methodologies, a user may access automatic injection functionalities such as automatic injecting of associated sound clips based on user's tone, mood, keyword, or phrase during a conversation when certain phone function(s) and/or button(s) are pressed.

Reference will now be made in detail to exemplary embodiments of the invention as illustrated in the accompanying drawings. While the invention will be described in conjunction with exemplary embodiments, it will be understood that it is not intended to limit the invention to only the described embodiments or visual representations. To the contrary, it is intended to cover alternatives, modifications, and equivalents as may be included within the spirit and scope of the invention. References here in to examples and illustrations are exemplary in nature and not limiting.

During a phone conversation or the brief moment of recording a voice message, it is crucial that one can act or react to his thoughts instantaneously, making the task of locating and injecting a desired sound clip to the conversation an urgent and immediate task indeed. Therefore the methods described herein are well suited for providing a user friendly and efficient user interface for injecting audio files or sound effects for use in mobile phones and other portable devices. In the described embodiment, a portable device takes the form of mobile phones, land-wired telephones, cordless phones, PDAs, handheld computers, PCs, multimedia asset players, and the like. Accordingly, methods, systems and user interfaces for providing user supplied inputs to the portable device are described. Such user supplied inputs can include user supplied commands directed at playing (injecting) specific files, such as digitized audio files in the form of, for example, MP3 files.

In one embodiment, a two-level hierarchical ordered graphical user interface is provided that facilitates a user file selection procedure. In this specific embodiment, particularly for mobile phones, there are two orders (levels) of interfaces for injecting sound clips into a phone conversation: the first (highest) order interface (also referred to as a Sound Categories interface) provides a list of user selectable sound category items each of which, when selected, results in an automatic and instant transition to the second order interface (also referred to as Sound Files interface) with a list or collection of user-selectable audio files associated with the selected category item. In one of the described embodiments, the interface includes other user selectable items associated with the previously selected item from the higher order user interface. In this way, a user can automatically transition from a first order interface to a second order interface (and vice versa) via direct transition.

In a particular embodiment, the portable device is a pocket-sized mobile phone having a display screen arranged to display the various user interfaces and includes a corresponding user input device. The user input device may be any or the combination of the followings: a manually operated switch, button, wheels, numeric keypad, speech recognition functionality, and/or other such contrivances. Accordingly, the invention will now be described in terms of a portable device capable of storing a number of multimedia assets. For example, in the case of the multimedia asset player being an MP3 player or a mobile phone, the multimedia assets can include MP3 files, AAC-Plus, as well as any other appropriately formatted data or CODEC files. Media assets and multimedia assets are also synonym to, but not limited to, sound files, sound clips, sound bites, audio files, audio clips, and sound effects.

For example, in a particular embodiment, the available media assets are arranged in a hierarchical and alphabetical manner based upon a selected number and type of groupings appropriate to the available media assets. For example, in the case where the mobile phone is capable of playing MP3 or other format files, the available media assets take the form of MP3 files (each of which corresponds to a digitally encoded sound clip or other audio rendition) stored at least in part in the device or at the central server (in another embodiment). The available media assets (or in this case, sound clips) can be grouped or organized in any manner deemed appropriate. In one arrangement, the audio files can be arranged hierarchically as Sound Categories at a first level, a collection of sound files associated with the particular category at a second level. The hierarchical order of interface levels continues with other media assets. For example, a more complex audio such as songs and audio books may have deeper levels of interface, but in most cases, locating and injecting a sound clip into phone conversations only requires a two-level interface for the sole purpose of this invention.

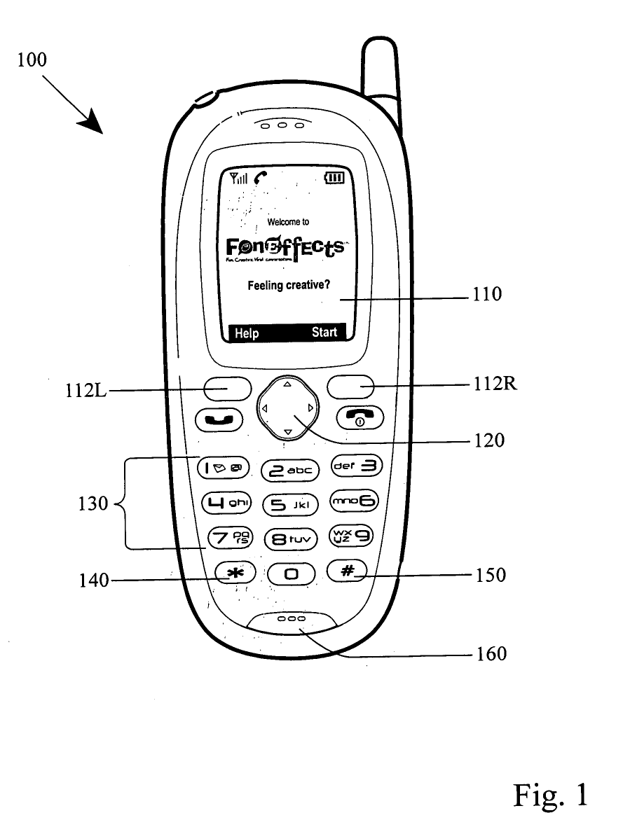

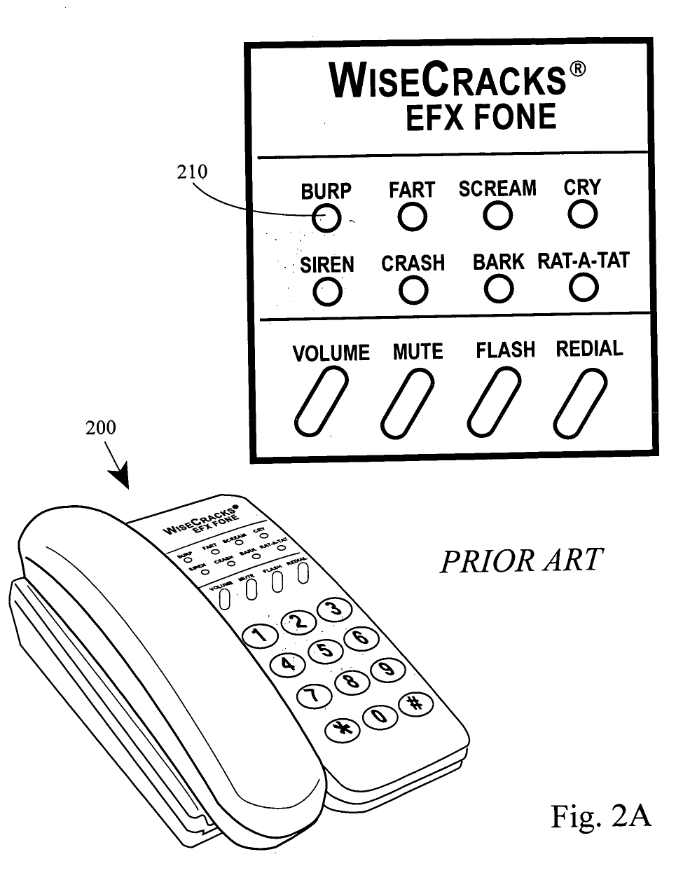

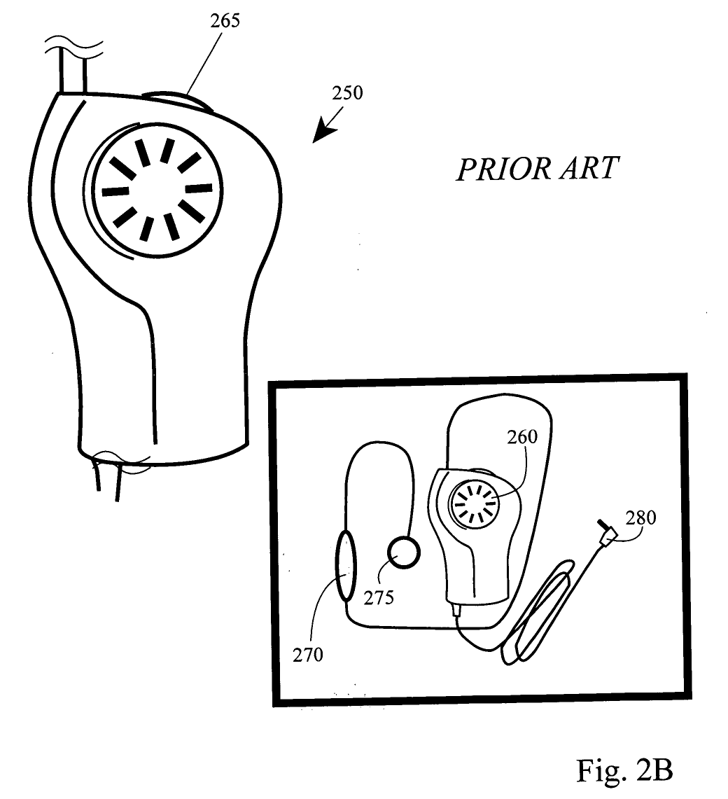

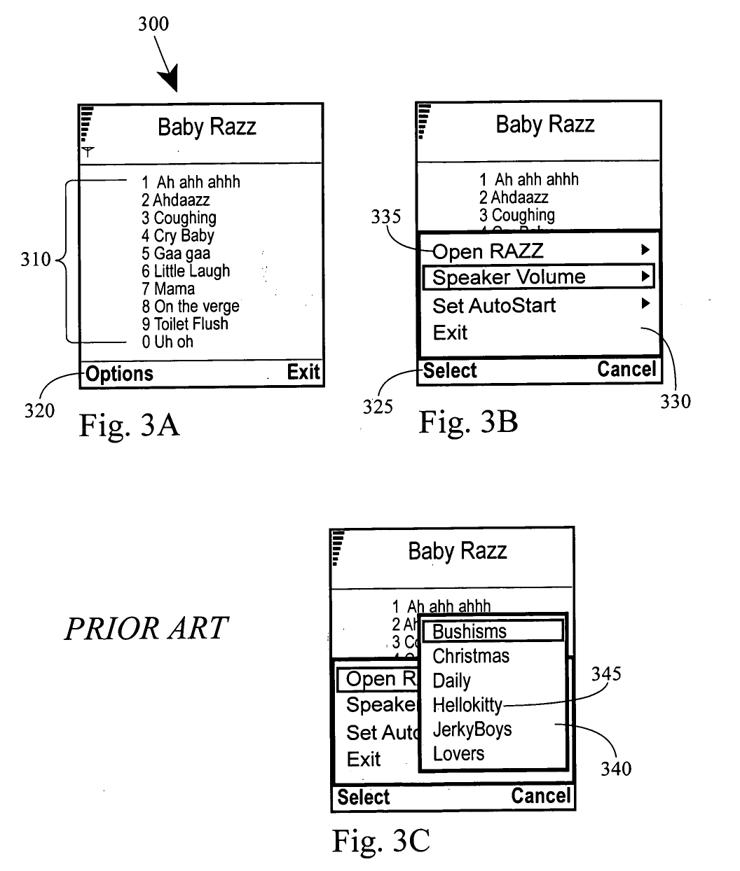

One type of typical mobile phone 100 handsets can be seen on FIG. 1. In one embodiment, the mobile phone 100 serves to store a plurality of media assets (e.g., sound clips) in the file system (not shown). When a phone user desires to play (inject) a particular media item to the conversation, a list or collection of available media assets is displayed on the display screen 110. Then, using either the keypad 130 (consists numeric keys, STAR (asterisk, *) key 140, and POUND (#) key 150) or navigational device 120 with soft key buttons 112L and 112R, or any other input device, user can select and play one of the available media assets (sound clips). Navigational device 120 can be a five-way (scroll & selection) button, touch wheel, navigation stick/ball, three-way (scroll & selection) scrolling barrel, touch pad, buttons, etc. In addition to the navigational device, a user may opt to use the numeric keypad for even faster user input and selection. For instance, instead of having to navigate to a particular item before making a selection, user may simply press the corresponding numeric key to select the desired item with fewer key strokes.

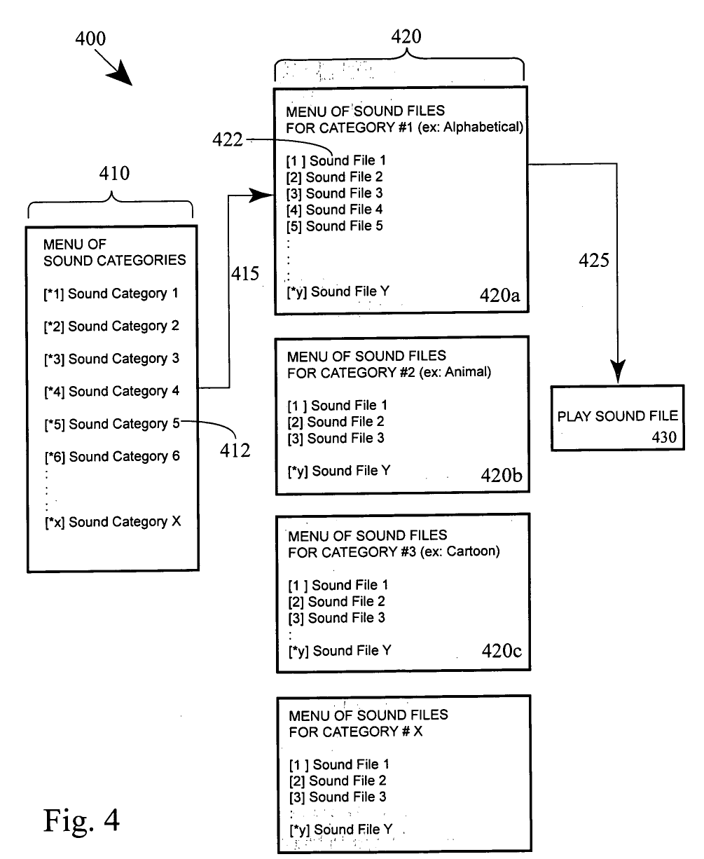

FIG. 4 illustrates a hierarchically ordered interface 400 used to navigate through stored media assets of interest to a user in accordance with an embodiment of the invention. It should be noted that in the described embodiment, the interface 400 is navigated by the user scrolling up and down within a particular level in order to peruse and eventually select a particular item located within that level. Or simply use the numeric keypad 130 to press the number which corresponds to the desired item. Once an item is selected on the first order interface 410, the first order menu 410 is automatically rolled down to hideaway and instantly transitioned 415 to display a second order interface 420 associated with the selected item. For example, at the first order interface, a list of sound categories (Alphabetical 420a, Animal 420b, Cartoon 420c, etc) corresponding to the available audio clips is displayed. Upon selecting the desired sound category 412, substantially instantly, from a user perspective, the first order (Sound Categories) interface 410 rolls down as a default function (similar to the Microsoft Windows' Toolbar auto-hide function). At the same time, the second order (Sound Files) menu 420 is automatically and substantially instantly displayed. In order to select a particular sound file 422, a user scrolls “vertically down” the list 420 (usually accompanied by a pointer such as a bold typeface or by highlighting the adjacent item) until a desired input item is reached. Or simply uses the numeric keypad 130 to press the item number which corresponds to the desired file item to trigger a particular sound clip within that level. In addition to navigational device 120, a user may opt to select the desired sound category and sound file item via a keypad or any user input device connected to the applicable device. When chosen audio file 422 is activated, it immediately transitions 425 to the NOW PLAYING interface 430 and the sound clip 422 is played and injected to the voice path of the phone conversation.

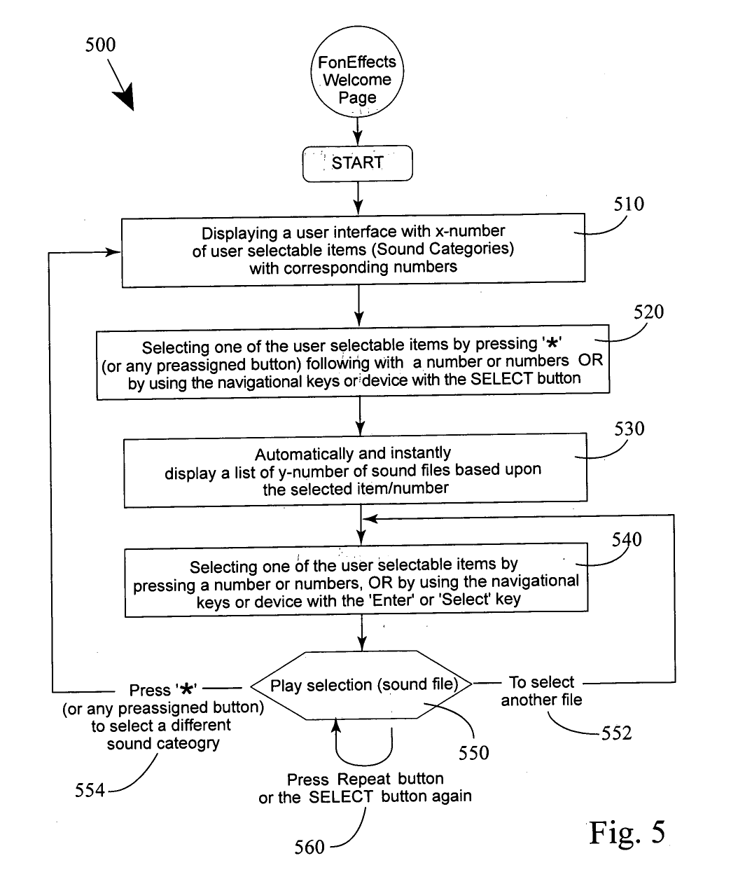

FIG. 5 is a flowchart 500 illustrating a particular process for selecting a particular one of a group of stored sound file in accordance with an embodiment of the invention—more particularly, for mobile phones. Accordingly, at 510, a first order (Sound Categories) interface 410 is displayed having a collection or list of first order user selectable items 410. In this example, the first order interface 410 is the list of sound categories whereas the first order user selectable items 412 correspond to the various categories indexed. Next, at 520, at least one of the user selectable items 412 is selected and subsequently, at 530, an automatic hideaway of the Sound Categories menu 412 instantly displays a second order (Sound Files) interface 420 corresponding to the selected item. At 540, at least one of the user selectable items (sound files) 422 from the list is selected and therefore, at 550, the selected file immediately injects to the voice path of the phone where it's audible to both parties on the phone. At 560, a user may press (depending the model of the phone) the ENTER or OK or SELECT key, normally one of the soft keys, again to repeat the played audio clip. Pressing the STAR (*) button 140 twice consecutively would also produce the same effect of the “repeat” functionality. At 552, user may opt to choose another sound clip 422 from the same Sound Files interface 420a. Otherwise, at 554, user can press the STAR key 140 once (or any other pre-assigned button) on the phone to display the first order (Sound Categories) interface 410 to select another sound category folder 412 from the list.

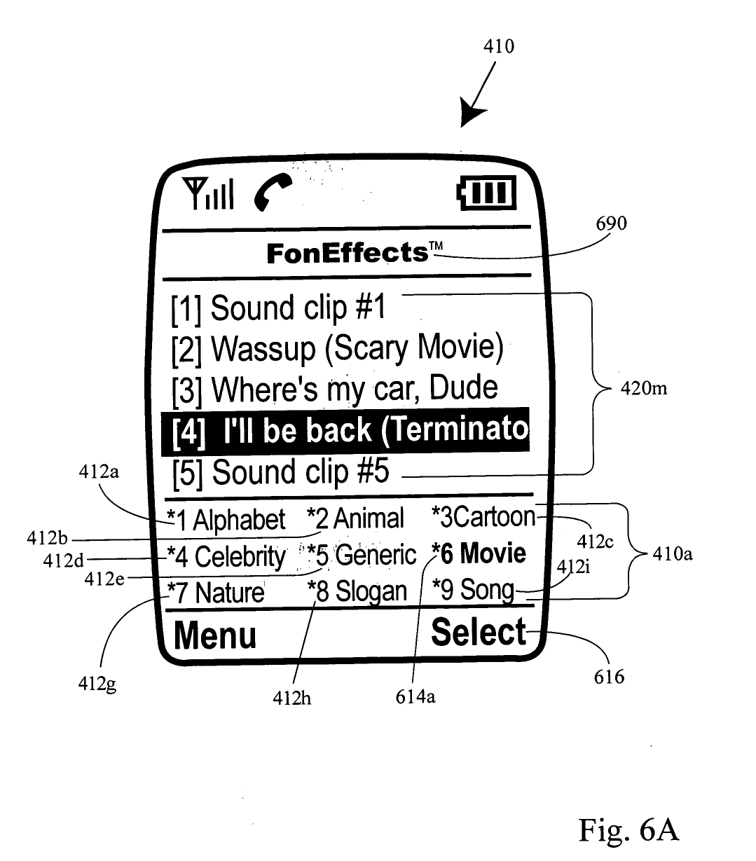

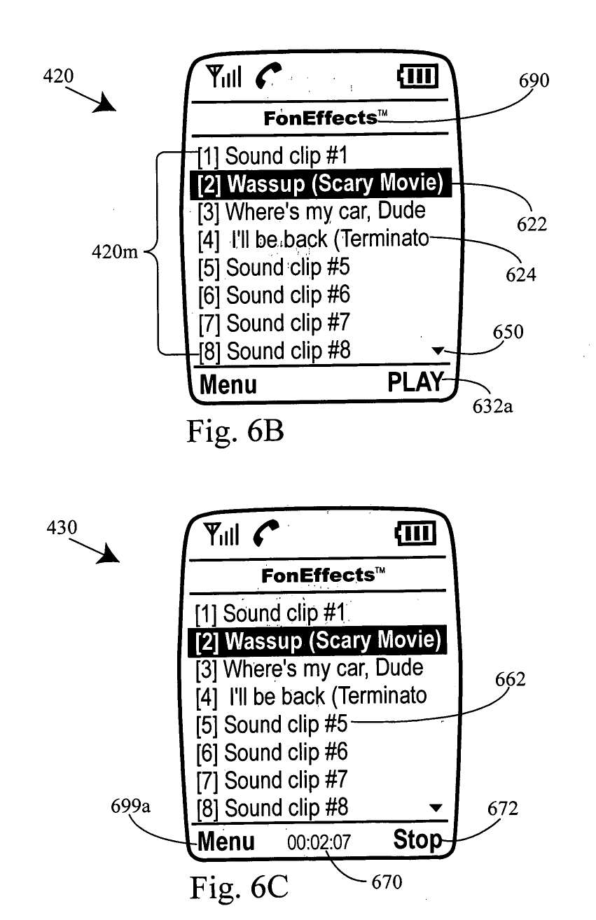

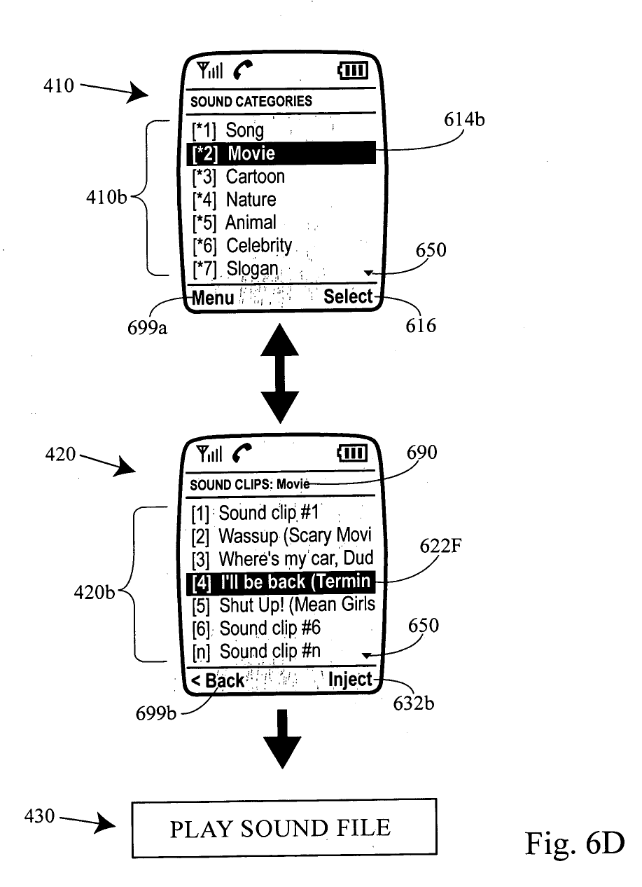

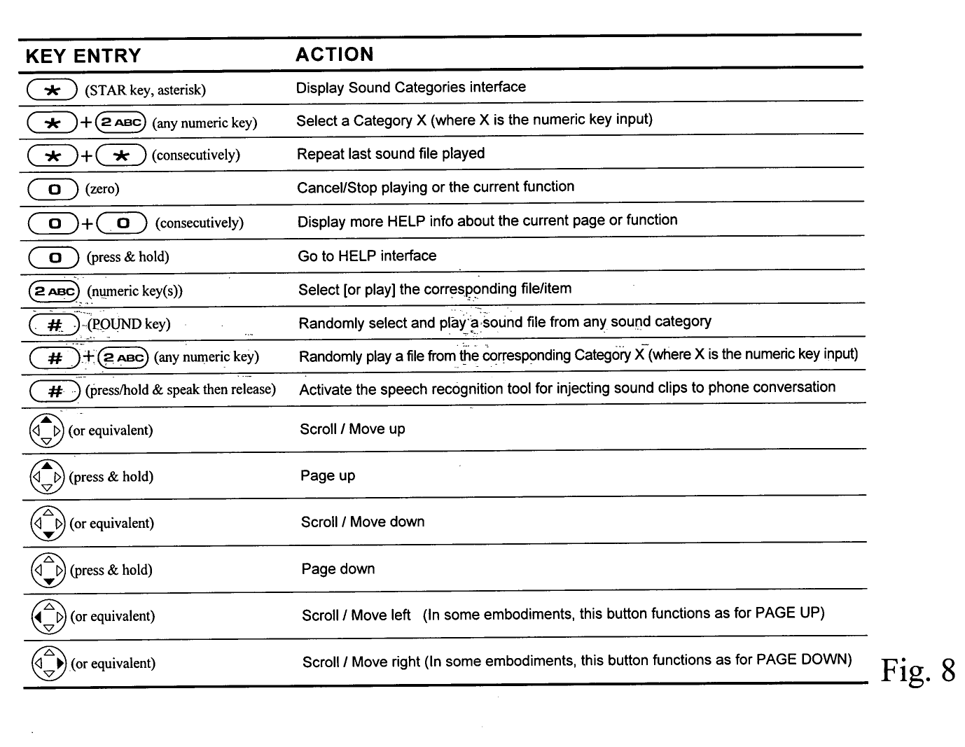

FIGS. 6A-6C illustrate a various exemplary user interfaces consistent with selection and play of a media asset in accordance with one embodiment of the invention. One should note that the various user interfaces illustrated in FIGS. 6A-6C correspond to particular embodiments of the SOUND CATEGORIES interface, the SOUND FILE interface, and the NOW PLAYING interface. Accordingly, it should be further noted that each of the interfaces described are incorporated into a representative mobile phone 100 or other portable device having a display 110 and a user input device 120 that includes soft key buttons 112L and 112R, a keypad 130, and the Pound (#) and STAR (*) keys. It is well to note that in this particular embodiment, the STAR (*), Pound (#), and ZERO (0) keys are multi-function buttons. Accordingly, the STAR (*) button is to actuate the Sound Category interface menu while pressing this key twice will repeat the last played sound clip. More information about key functionality is provided on FIG. 8.

It should be noted that for sake of simplicity, only a single selection path is shown corresponding to a single selection item (e.g., Movie). Accordingly, in one embodiment, a Sound Categories interface 410 provides a collection (list) 410a of sound categories that includes an ‘Alphabetical’ item 412a, an ‘Animal’ item 412b, a ‘Cartoon’ item 412c, a ‘Celebrity’ item 412d, a ‘Generic’ item 412e, ‘Movie’ item 614a (bolded), a ‘Nature’ item 412g, a ‘Slogan’ item 412h, and ‘Song’ item 412i. Each item in the Sound Categories interface 410a is a folder containing sound files 422 that are associated to that particular category item 412. As shown on first order interface 410a on FIG. 6A, the bolded item 614a indicates the active (selected) category. The Sound Categories interface 410a is customizable, hence names and number of sound category items may be specified, arranged by user. It should be noted that each item is associated with a particular grouping of the multi-media assets (which in this example are audio clip files 422) stored in the device or on the server (in an alternative embodiment). For example, the ‘Cartoon’ category 412c is associated with a number of customizable cartoon sound effects (e.g., the famous ‘What's up Doc” from Bug's Bunny) whereas the ‘Movie’ category folder is associated with particular clips from popular movie clips, and so on.

Therefore, once a user selects either the ‘Alphabetical’ category, the ‘Movie’ category, or any category on the Sound Categories menu 410a, an automatic and instant transition to a second order interface 420 (Sound Files interface 420) occurs corresponding to the selected item. For example, if the user selects the ‘Movie’ item, an automatic transition to the second order menu 420m occurs that concurrently displays all sound clip files the user owns that are associated with MOVIE as shown on FIG. 6B.

Once in a particular second order interface (Sound Files interface) 420, the user has the option of injecting any sound clip by selecting a desired file from the list 420m. For example, if the user selects “Wassup” 622 from the film Scary Movie by pressing the PLAY button 632a (or, in some embodiments, the INJECT button 632b), the audio clip will be instantly played and injected into the phone conversation. Within the same Sound Files menu 420m, the user may select another movie sound clip to be played. If the user has selected the “I'll be back” clip 624 from the Terminator movie, Arnold Schwarzenegger's famous quote will be played and injected to the conversation. At this point, when the user plays a particular audio file, an automatic transition to a NOW PLAYING interface 430 (as shown on FIG. 6C) occurs having an audio information display consistent with the selected file 622 as well as all inactive file items 662 being temporary grayed out (or otherwise changed to a different identifiable color or font, etc). In this exemplary embodiment, the counter 670 is a reverse-counting mechanism, which means it shows the remaining time of the audio playback, but user may opt to choose a regular forward counter on the user preference setting (not shown). As revealed on FIG. 6C, the user may press STOP 672 to terminate or cancel the sound clip at anytime during its playback.

The user may trigger the MENU function 699a for other options and setting configurations by pressing the assigned button, for example, the LEFT SOFT KEY 112L. As established on FIG. 6B, if a DOWN ARROW ICON 650 and/or UP ARROW ICON (not shown) is shown on the Sound Files interface 420, that means there are more items below and/or above, for the DOWN and UP arrow icon, respectively. The user may press either the UP or DOWN ARROW KEY or use the navigational device to scroll up or down on the list. Additionally, the user may press the designated button, e.g., pressing the RIGHT or LEFT ARROW KEY (not shown) to NEXT or PREVIOUS screen of content, respectively. If the page currently being viewed has more than one page (or the list currently being displayed has addition items), the page (list) will be moved down one page (screen) when the RIGHT ARROW KEY is pressed. Similarly, the page (list) will be moved up one page when the LEFT ARROW KEY is pressed. Other than the ARROW KEYS, the designated buttons could be any keys or any type of user input device.

If the list of user selectable sound files is lengthy, the user may press and hold one of the number keys (2-9) to locate a sound clip beginning with the first letter on that key (or closest following), given that the list is displayed in alphabetical order. For example, within the Sound Files interface, pressing and holding key-8 will result in transition to and instantly displayed the first sound clip beginning with “T”. To go to the next alphabet on that key—letter “U”, user needs to press the key-8 again. And pressing the same key once more will jump to “V” but, after the last letter on the particular numeric key is reached, it will loop back to the first letter on that particular numeric key if it is pressed again.

In one embodiment, should a user want to disable the AUTO HIDE function for the Sound Categories interface, even when a category item is crime selected, the Sound Files menu 420 will be presented on the same screen as shown FIG. 6A. Otherwise, by default, the Sound Categories menu 412 will automatically roll down upon selection and all user-selectable audio clips 422 on the Sound Files interface will be displayed on the full screen as shown on FIG. 6B. As revealed on FIG. 6A, one advantage of the present invention is the ability to stack the second order interface 420 on top of the first order interface 410 for quick view and even faster access to a particular sound category item.

Accordingly, FIG. 6A shows a particular implementation of the first order interface 410 displayed with second order interface menu 420m behind. In order to select the MOVIE item 614a, the user navigates with the user selection device until the MOVIE item 614a is rendered selectable (as noted by a bolded typeface). Once the desired item is bolded (or otherwise visually distinguished), the user selects the bolded item by triggering a selection protocol by, for example, pressing the RIGHT soft (selection) key 112R.

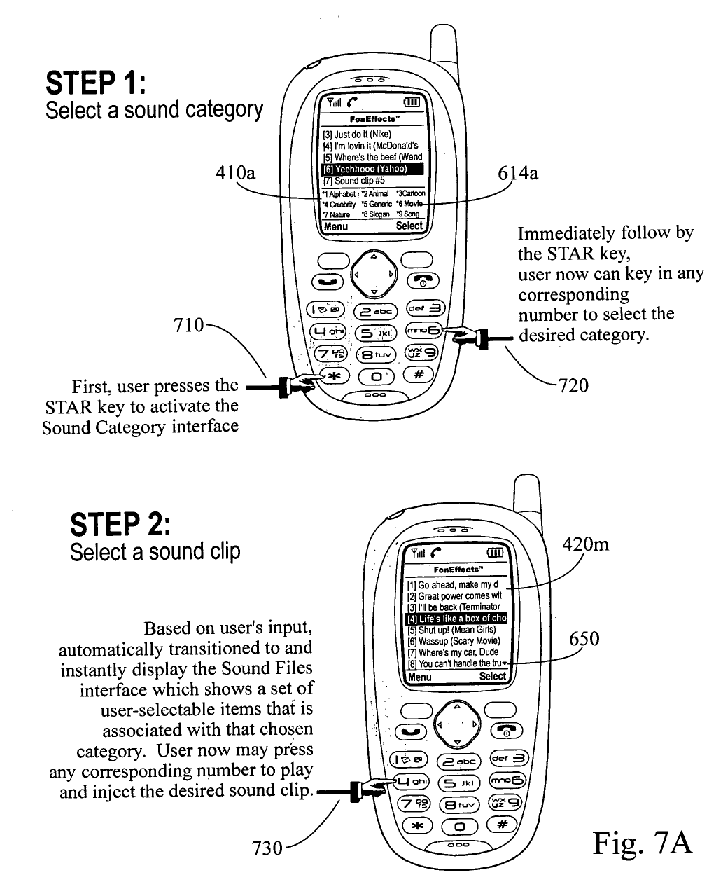

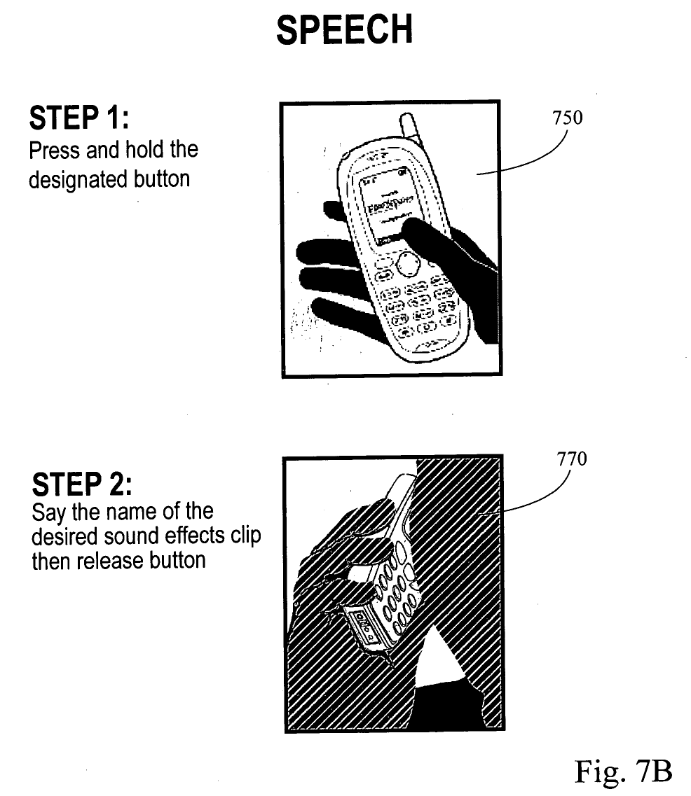

On a graphical user interface for mobile phone and the alike, quicker key entry is available to users for supplying user inputs and selections. It is particularly well suited for locating and selecting a specific sound file in speedy manner. A user may opt to select the desired sound category item without having to use the navigational device to navigate up and down or side by side until a desired input item is reached. For example, shown on FIG. 6A, if sound clips from MOVIE 614a are pre-assigned to Sound Category #6, the user can press STAR (*) follow by the numeric key six to choose the sound category of MOVIE. The user is provided the capability of navigating the user input menu and supplying user selection in any manner that the user deems to be most convenient and efficient. More details for quick key entries are discussed below with respect to FIG. 7A.

Upon selecting a particular sound category (Movie, for example), there will occur an automatic and instant traversal 415 to a second order interface 420 that includes a display of a list of sound files corresponding to the selected item (sound category folder).

In order to select a particular sound clip 422, the user scrolls vertically (or in a different manner) in the MOVIE list 420m until the desired item is rendered selectable or other visually distinguished (as noted by a highlight bar 622). Once the desired item is highlighted, the user selects the highlighted item by triggering a selection protocol by, for example, pressing RIGHT soft key 112R. Once selected, the chosen sound file 622 starts to play as shown at the NOW PLAYING interface 430 on FIG. 6C. Again, in addition to using the navigational device, the user can also make a selection by keying the number(s) from the keypad 130 that correspond with the particular sound file. For example, pressing the number (2) key would also generate the same result.

They will thus be seen that, for injecting sound clips into phone conversations, an embodiment only requires two levels of hierarchical order interface: Sound Categories interface and Sound Files interface. However, for music listening or other media asset playback functionality (such as song and audio book playing), a user may need to interact with more order interfaces. The procedure of navigating to sub-order interface is continued until a particular media asset or track from a collection of full length of the original songs (not shown) or within an audio book (not shown) is selected.

FIG. 6D presents exemplary user interfaces consistent with selection and play of a media asset in accordance with an alternative embodiment of the invention. The process of injecting a sound clip into phone conversation is the same but the interface breaks the first order (Sound Categories) interface 410 and second order (Sound Files) interface 420 into different screens. Instead of displaying a overlay window of the Sound Categories interface on top of the Sound Files interface as shown on FIG. 6A, on this particular embodiment, all user-selectable items are listed vertically 410b (or arranged in another quick-read manner) for the Sound Categories interface. In order to select a particular sound category folder, user may simply press the corresponding number on the list 410b or scroll “vertically down” the list 410b until the desired item is reached then press the SELECT key 616 to actuate that particular category item.

Similarly, based on the user selection, there occurs automatically transitioning to and instantly displaying of a second order user interface 420 which reveals a list of all audio files 420m that are associated with user's selected sound category item, for instance, MOVIE 614b. Upon selecting a particular sound file 622, the selected sound clip will be played and the NOW PLAYING interface 430 will be displayed. After audio playback is stopped, should user wants to choose another sound category folder 410b, he may simply press the STAR key 140 or hit the BACK button 699b, or use any other appropriately functional control mechanism, to view the Sound Category menu 410b again.

As noted on the second order interface 410 on FIG. 6D, an indicator 690 of the selected sound category is shown on the top of the screen to inform the user which sound category folder he is currently in (that is, which category he has selected). This indicator 690 is associated with the sound category item 412, similarly to the bolded category item 614a shown on FIG. 6A. For instance, should a user have selected the SLOGAN category, this indicator 690 will read “Slogan” on the Sound Files interface 420. The indicator may vary in font style, color, and placement with different embodiments. It may be substitute with other graphics, icons, or different visual representations. This location for shown indicator 690 may also be used to indicating other function or section options such as MENU options, HELP interface, or the product brand, etc.

Although the hierarchical order user interface uses only two levels for injecting sound clips into phone conversations, it should be noted that the procedure described above is path-wise bi-directional in that the user can go in either direction along a selected path—back and forth with the soft selection keys 112L and 112R. It should be further noted, that in some embodiments, it is desirable to directly transition from the NOW PLAYING interface 430 to the first order interface 410 (and vice-versa) without displaying any of the intervening interfaces for the deeper navigational interfaces.

FIGS. 7A-7B show diagrammatic schemes of exemplary user interfaces and advantageous methodologies for injecting a sound clip into a phone conversation easily and quickly. With particular reference to FIG. 7A, the two methodologies used are illustrated by a sequence of steps as follows: (1) Select a Sound Category and (2) Select the Sound File to be injected or played.

As may be seen in the described sequence of steps, user simply presses the STAR (*) key 710 follow by the corresponding number 720, that is assigned with a particular sound category (grouping), to select the desired item for Step (1) on the KEY ENTRY method. For example, pressing the STAR (*) key immediately with the numeral (6) key, user has chosen the sound category of MOVIE 614a on the index 410a. Based on the selection, first order interface 410a rolls down automatically and then instantly display a second order (Sound File) interface 420 with a list 420m of sound effects files with a corresponding number assigned to each item. In Step (2), all that is needed is for the user to simply select the desired sound file to be played (injected). For instance, the user presses the numeral (4) key 730 to trigger Forrest Gump's famous quote “Life's like a box of chocolates . . . ” Should the user want to play another sound file, he only need press the corresponding number of the audio clip he desires. Or if he wants to inject a particular file from another sound category folder, he just repeats Step (1) of this simple procedure.

Similarly, with particular reference to FIG. 7B, the methodology used is illustrated by a sequence of steps as follows: (1) Press and hold a designated button and (2) Speak the keyword or phrase, that is pre-assigned with a particular sound file, to be injected/played. Keyword/phrase for speech activation is, for example, the first one, two, or three word(s) or the entire name of the sound file. For instance, a user may press and hold 750 the designated button to initiate speech recognition and say 770 “Life is like” directly to the phone's microphone 160 or any appropriate hand's-free microphone (not shown) then release the depressed button when finished speaking. Automatically and instantly, Tom Hank's famous line “Life's like a box of chocolates, you never know what you are going to get” will be injected to the conversation. As another example, a user may opt to speak the entire sound clip name, e.g., “Girls just want to have fun,” to trigger the clip of Cindy Lauper's hit song.

As apparent in FIG. 8, in one embodiment button functionality may be pre programmed for easy and fast input/selection using the keypad. For example, consistent with the descriptions in the table, when pressing the STAR (*) key 140, the Sound Categories interface 410 will automatically (by default) roll up and displayed. Immediately following the STAR key 140, if user presses a numeric key(s), it will take him to the corresponding sound category folder and instantly display a list of all sound files that are associated with the selected sound category. If he presses the STAR key 140 twice consecutively, it will repeat the last played sound clip 560.

Should the user wants to stop the playing sound file or terminate the current operation, all that is needed is to press the ZERO (0) key once. However, if pressing the ZERO key twice consecutively is performed, the HELP information on that particular page or specific functionality will be displayed. Moreover, if the user will press and hold the ZERO key for a predetermined time it takes the user to the HELP section 1800 with more options for user selection.

The POUND (#) key 150 serves as an automatic random selection. For instance, if the user wanted to randomly select and inject an available sound clip from any sound category, he only needs to press the POUND key 150 once. However, if he wants to randomly select and inject an available sound clip from a specific sound category, he needs to immediately press a corresponding numeric key(s) after the POUND key 150.

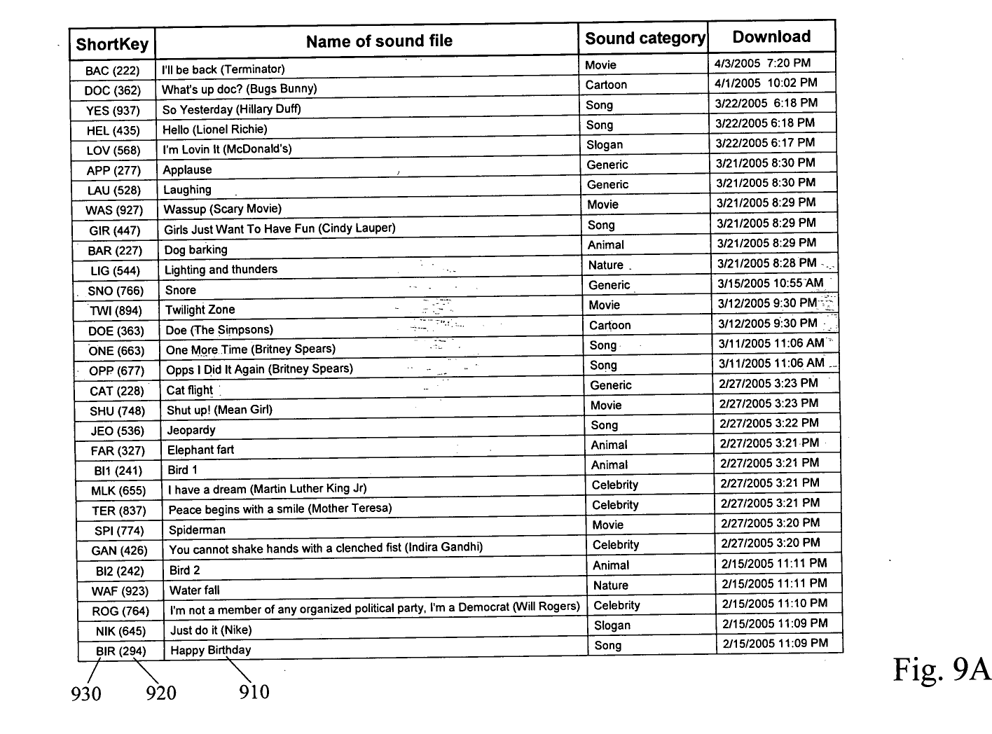

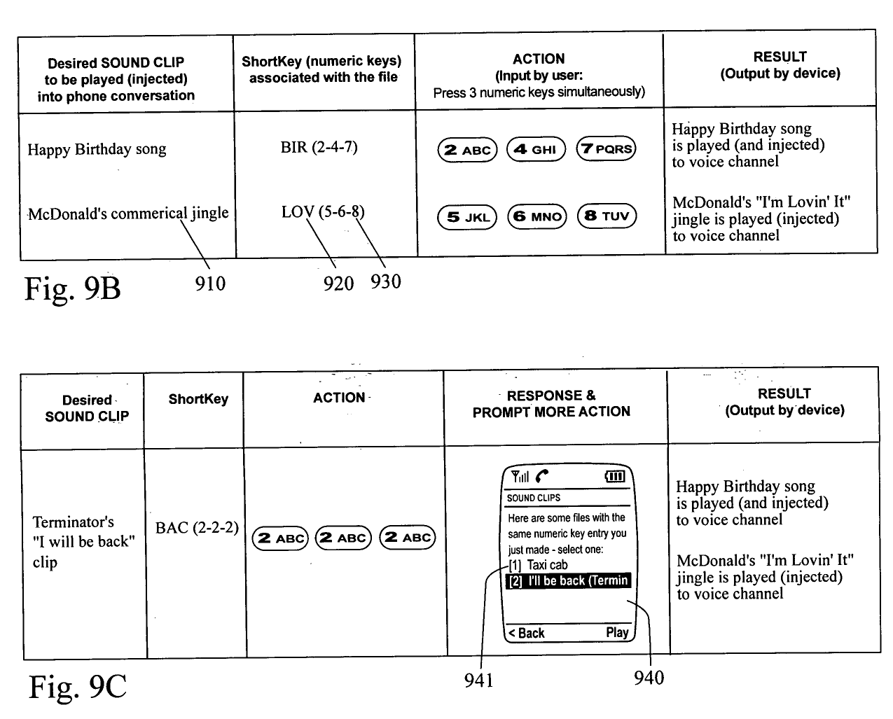

FIG. 9A shows some a list of sample 3-key abbreviated identifiers 920 and their sound file names 910. Abbreviated identifier inputs 930 are for allowing user to quickly trigger a particular sound file 422 that has been assigned with a specific grouping of three letters 920 and three equivalent numeric digits 930. The user may play a sound clip by pressing three numeric keys consecutively that is designated for three equivalent letters.

FIG. 9B describes more examples of using abbreviated identifiers. In one embodiment, the user presses the 2-4-7 keys consecutively for the equivalency of B-I-R; hence, the “Happy Birthday” jingle will be played. He may punch L-O-V 920 which is equivalent to the 5-6-8 keys 930 to play the McDonald's ‘I am lovin it’ jingle 910 just for fin. Or the user triggers Jeopardy's theme song while waiting for an answer or response by pressing J-E-O (5-3-6) on the phone's keypad 130 to express a timely issue.

FIG. 9C illustrates the possibility of having duplicated matches of numeric key entry for abbreviated identifiers (3-key I.D.) 920. Should there be more than one match for the same numeric key entry a user will be presented with a list of all the available sound files 940 that have the exact same numeric keys even though 3-key I.D. may be different. For example, in a particular embodiment, if the user presses 2-2-2, it will instantly present two sound clips 940 for the user to choose from. Thus the user has one sound file of ‘Taxi cab’ 941 that spells C-A-B for its abbreviated identifier and another clip that with abbreviated identifier of B-A-C for the Terminator's famous “I will back” line. With two matches for the 2-2-2 key input, or any other multiple sound file selection input, the user needs to further specify the sound clip he has in mind.

Although, in the example, all the sound effects files already have a pre-assigned 3-letter and equivalent numbers abbreviated identifier associated with them when downloaded from a server (not shown) or otherwise loaded into the device; these letter groups 920 can be customized or renamed by the user for self-understanding and easily recall. A user also has a choice to activate or turn off each of the abbreviated identifier. It can be any available letter combination. For instance, instead of using B-I-R, user may elect to H-A-P (short for happy) or H-B-S (abbreviation for Happy Birthday Song). It will be understood that abbreviated identifiers may be more or less than three digits (letters) long.

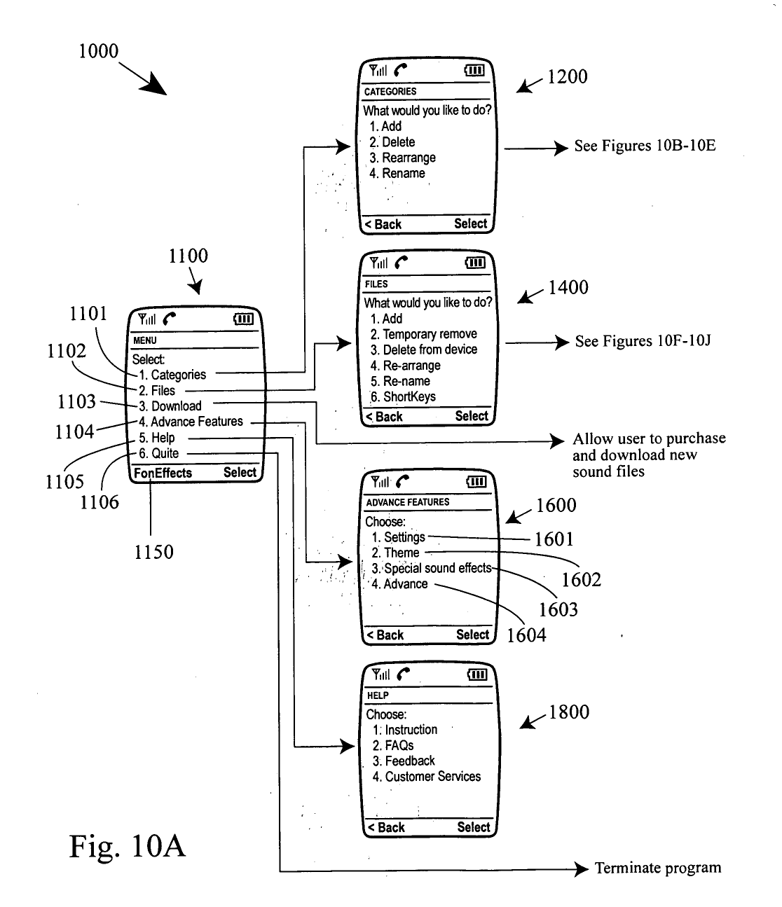

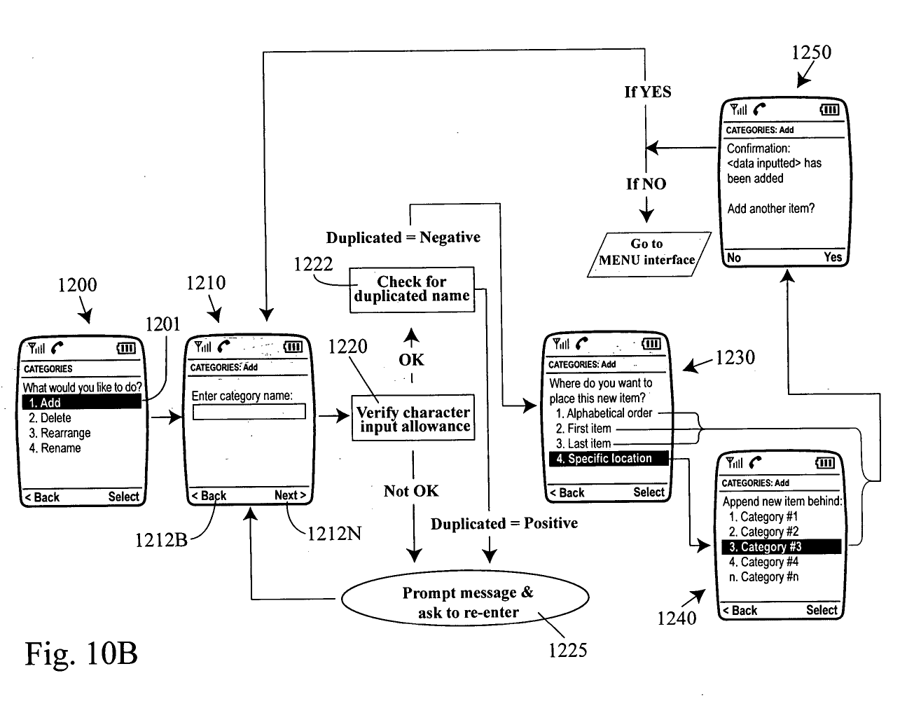

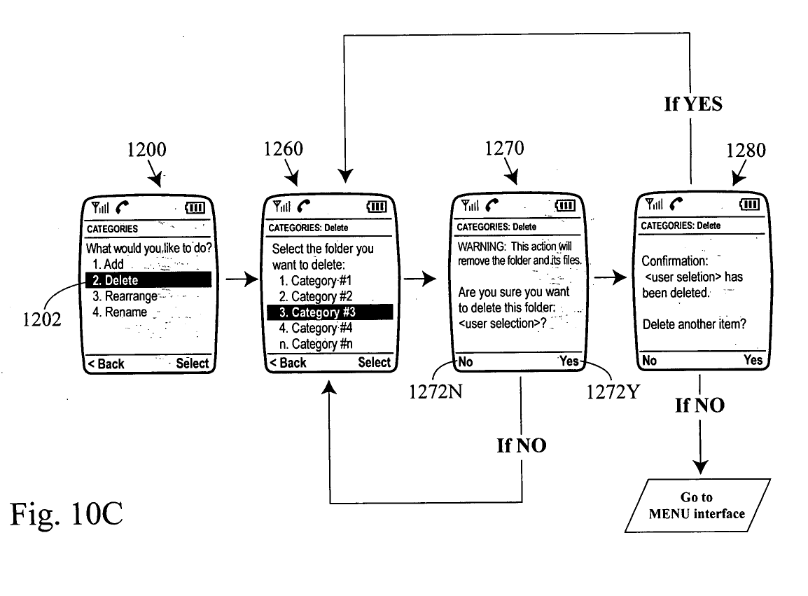

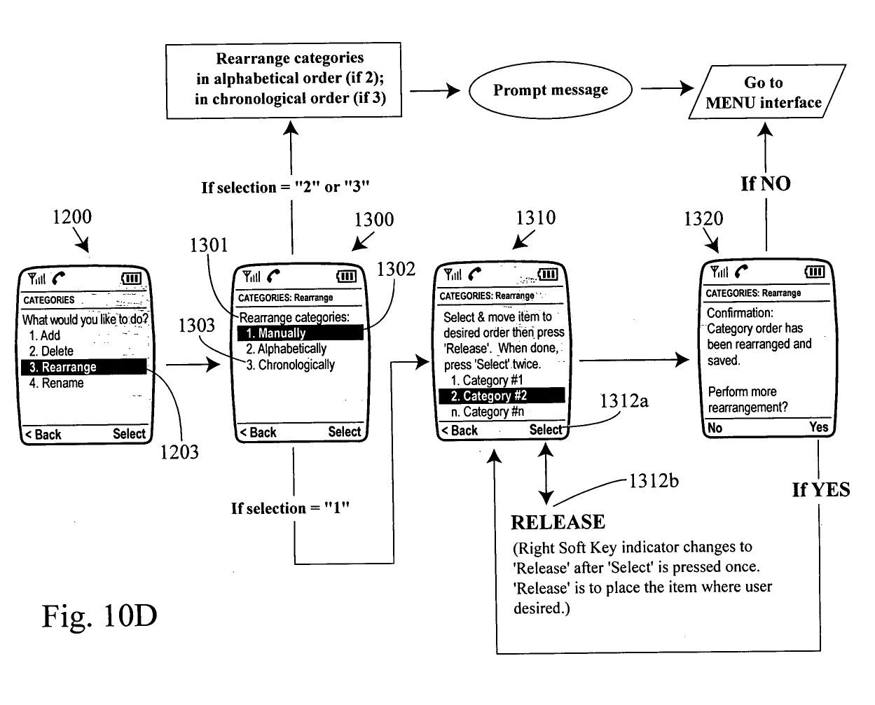

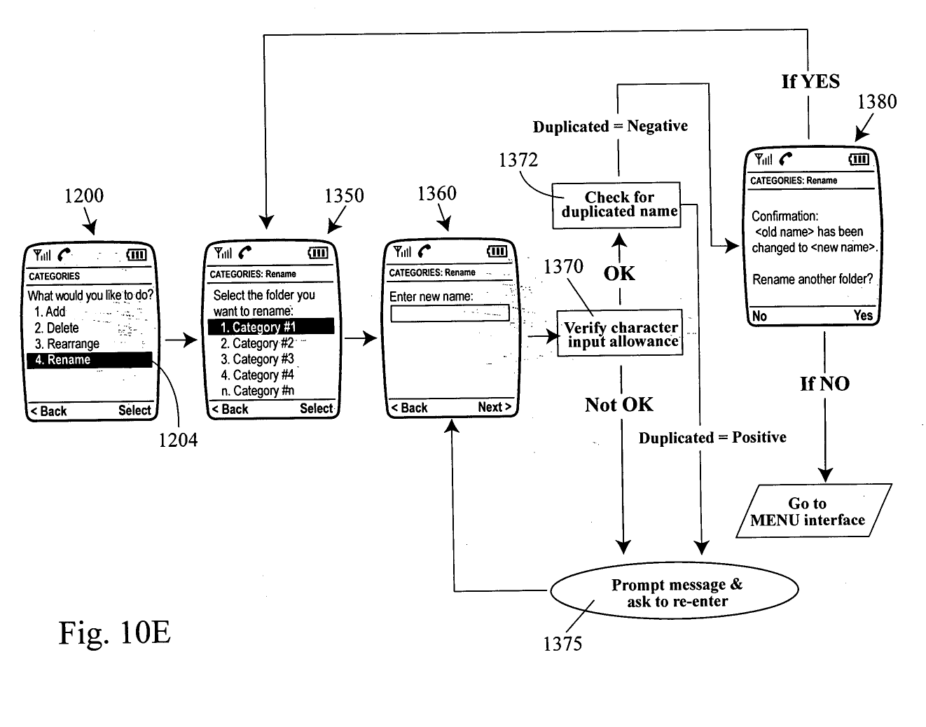

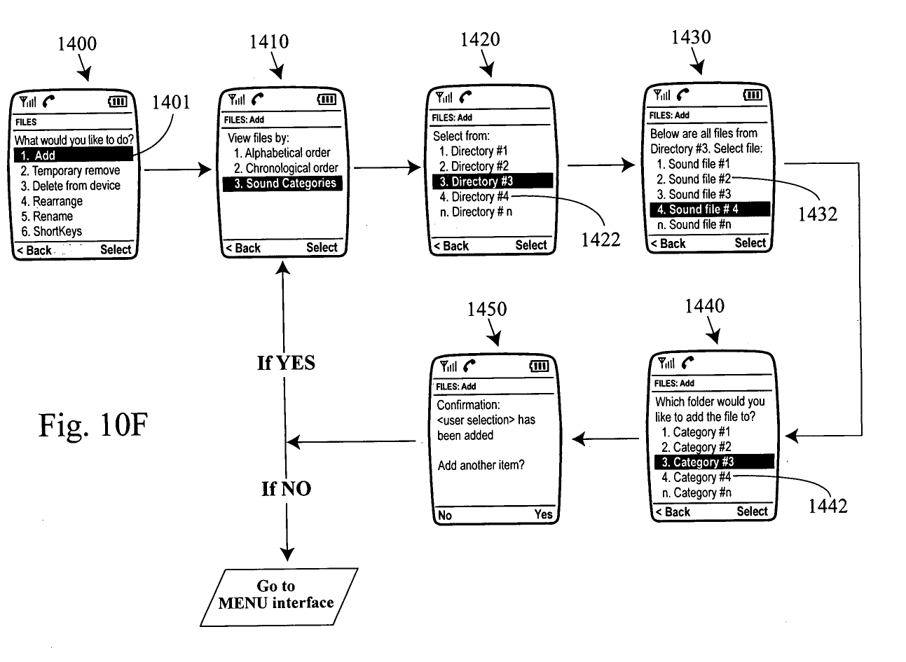

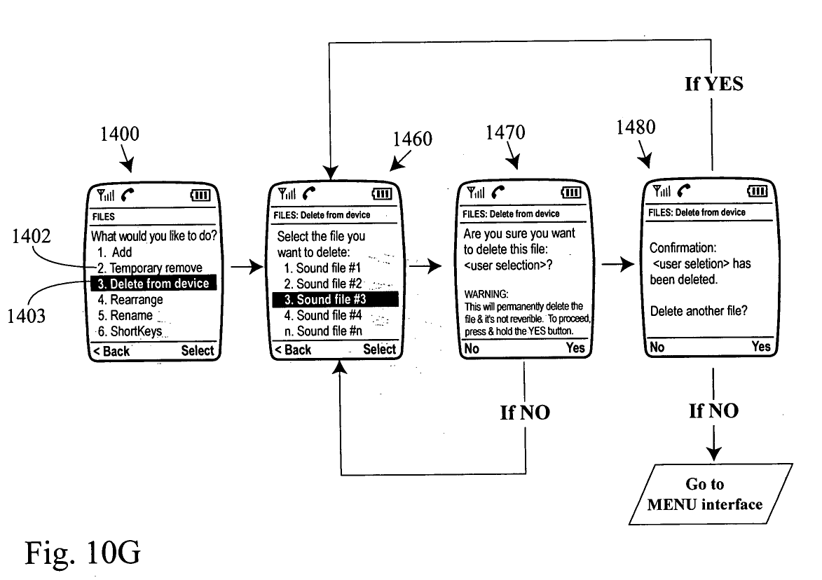

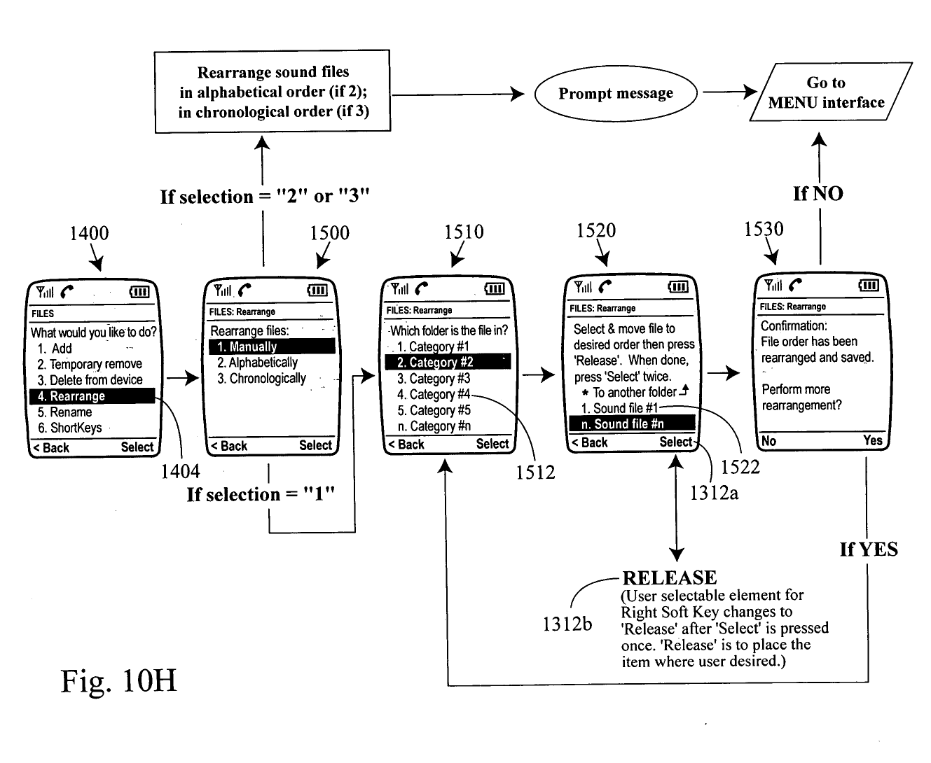

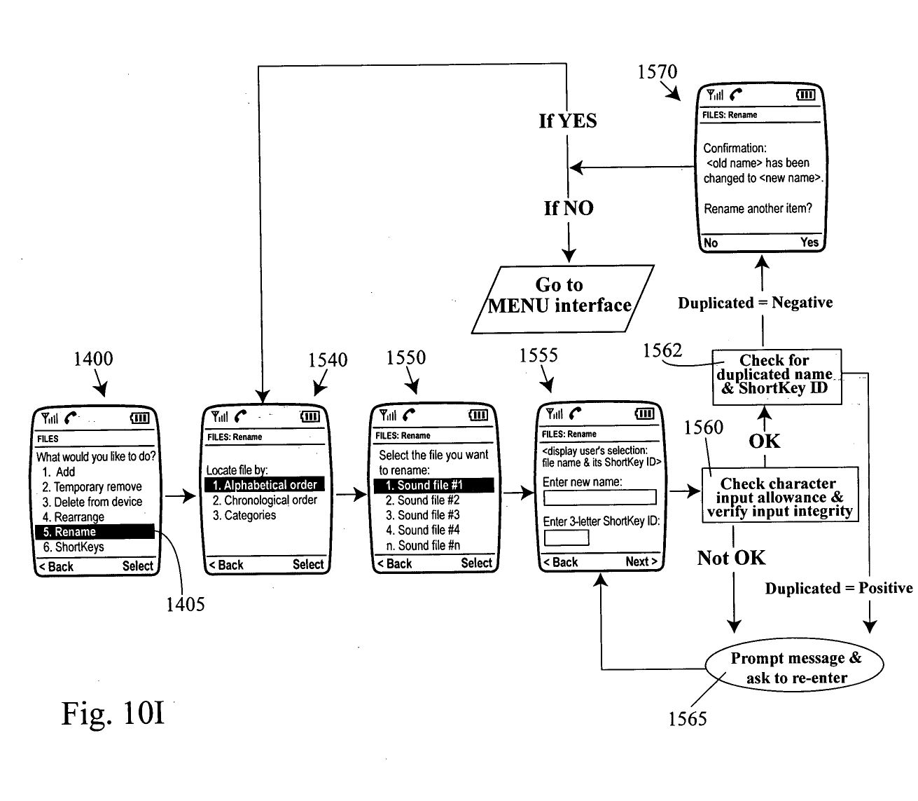

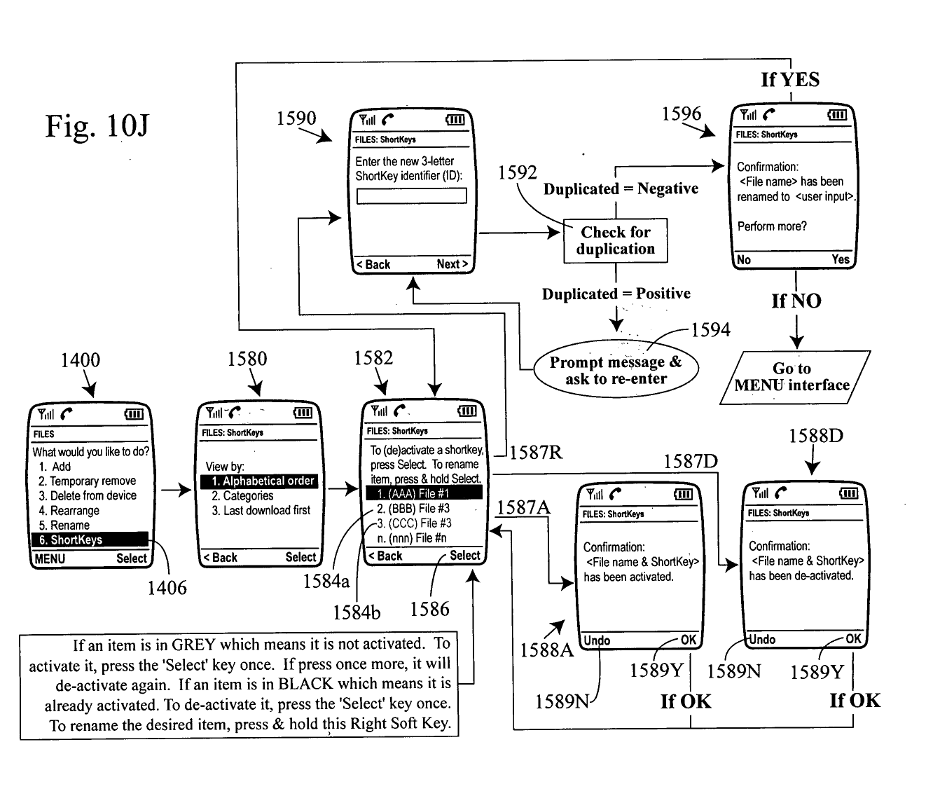

FIGS. 10A-10J illustrate the possibilities of the MENU options and its sub-menus, and various exemplary user interfaces consistent with user-selectable menu options in accordance with an embodiment of the invention. In a particular embodiment shown on FIG. 10A, the MENU interface 1100 consists of the following user-selectable menu items: (1) Categories 1101, (2) Files 1102, (3) Download 1103, (4) Advance Features 1104, (5) Help 1105, and (6) Quit 1106. On the MENU interface 1100, the user may press the designated button, for example the FonEffects button 1150, to exit Menu interface 1100 and return to the sound effects mode and interface. Universally, other than in the sound effects mode, the user may press the ZERO (0) key at any time, at any section to cancel a particular function or terminate a particular operation to return to the MENU interface 1100. Or if more information or instruction on a particular function or section is needed, the user can press the ZERO key twice consecutively which result an instant displayed of appropriate information. If the ZERO key is pressed and held, for a predetermine time, at any section or interface, it will direct the user to the HELP interface where he can access more HELP options. Furthermore, generally the BACK and NEXT functions take the user back to the previous page or the next page as the names of the function imply. In addition to the user input device, the user can also access the menus and sub menus by using the keypad and pressing the numeric key(s) which corresponds to the item number. These diagrams, shown on FIGS. 10B-10J, illustrate the process and interfaces of the functionality on the menu items. It should be noted that for sake of simplicity, only a limited selection paths are shown corresponding to the menu choices. It will be further understood that different keys or other input devices can be assigned to provide different functions.

Menu Item (1), CATEGORIES 1101, allows the user to ADD a new sound category; DELETE a category; REARRANGE the order of categories; or RENAME any category name as shown on FIG. 10B-10E. Again the user may use the keypad for numeric key input or use the navigational device 120. If the navigational device is the choice of user input/selection, the user would need to navigate to the desired menu option then press the SELECT button to make a selection. Otherwise, the user can also access the menus and sub-menus by pressing a numeric key(s) which corresponds the menu number.

FIG. 10B shows the ADD feature 1201 from the CATEGORIES menu 1200 and illustrates the steps for adding a new sound category name to first order (Sound Categories) interface. Upon selecting the ADD functionality 1201, the user will be prompted to input the name of the new sound category. Should he change his mind not to proceed with this task, he may press the BACK button 1212B to return to the previous interface. After entering the required information 1210, the user presses the NEXT button 1212N to proceed. Immediately it verifies user's input 1220 to determine if user-input exceeded the pre-determined character quantity. If so, it will alter the intended function and ask him to reenter 1225. If data input is equal to or shorter than the maximum allowance, it proceeds to examine name duplication 1222. If the user-inputted a name that is already in existence, it prompts the user to re-enter 1225. Otherwise, it proceeds to prompt the user as to where he wanted to place the new category item 1230. The user can place the new item by ALPHABETICAL order or as the FIRST or LAST item on the interface. In this example, the user has selected SPECIFIC LOCATION, which means he wanted to place the new sound category item at his specified order. Upon selection, the user is transitioned to another interface 1240 where he will be asked to highlight an existing category item where he wanted to append the new item to by using the navigation device with the SELECT button or the numeric keypad. Next, a confirmation message 1250 will be shown, and the user has an option to add another category item or exit this function.

FIG. 10C shows the DELETE feature 1202 from the CATEGORIES menu 1200 and demonstrates how a user can delete an existing sound category folder from the interface. At 1260, he simply selects the folder he wanted to remove then presses the SELECT key. Upon making the selection the user will be alerted for further action of the irreversible deletion 1270. If selecting YES 1272Y, the category folder will be deleted, follow by a confirmation message 1280. Otherwise, it takes the user back to the previous interface 1260 with the NO 1272N input.

FIG. 10D shows the REARRANGE functionality 1203 from the CATEGORIES menu 1200 and illustrates how one can rearrange the order of category folders on the Sound Categories interface 410. Upon selection, the user may proceed to the next interface 1300 where he needs to indicate his preference for rearrangement: manually 1301, alphabetically 1302, or in chronologically 1303. If user has selected ‘alphabetically’ 1302, the Sound Categories interface 410 will display all the category items in alphabetical order from this point on. On the other hand, if he had chosen ‘chronologically’ 1303, all items on Sound Categories interface 140 will be arranged and displayed in chronological order which means the last modified item will be displayed first and so on. On the manual selection 1301, the user may rearrange the items manually as desired. On this process, all the category items will be shown on the interface 1310 and he may select the one he wants to rearrange. Upon choosing the item with the SELECT button 1312a, or with the corresponding numeric key, he now can move it up or down with navigational device 120 then press the same button again (which will now be shown as the RELEASE 1312b (or in other descriptive wording) functionality) to release the category item in the order to his liking. The button for SELECT 1312a and RELEASE 1312b acts as a multi-function button. It toggles between the SELECT 1312a and RELEASE 1312b functionality. Whenever the user is finished with rearranging the order to his liking, he needs to press the SELECT key 1312a twice consecutively to save the changes he made and to exit this interface. Upon providing the user's input, he will be prompted with a confirmation message 1320 and asked if he wants to rearrange another item (assuming there was at least one item rearranged; if no item ever been moved and rearranged before user exits the interface, it will prompted him with a slightly different message).

FIG. 10E shows the RENAME option 1204 from the CATEGORIES menu 1200 and illustrates the steps user need to rename a sound category folder. Upon selecting this functionality 1204, the user now needs to choose the category item he wanted to rename as shown at 1350. Then, at 1360, he needs to enter the new name for the selected category item. Immediately it verifies the user's input 1370 to determine if user-input exceeded the pre-determined character quantity. If so, it will alert the user and prompt him to reenter the information 1375. If the user's input is equal to or shorter than the maximum character allowance, it proceeds to examine name duplication 1372. If the user-inputted name already exists the process prompts the user to re-enter 1375. If the name duplication is negative, it proceeds to the next interface 1380 where a confirmation message is displayed.

Under Menu Item (2), FILES 1102, on the MENU interface 1100, the user may ADD a sound file (that has been already downloaded or otherwise entered into the device) to any of the sound category folders; TEMPORARILY REMOVE a sound clip from a specific category; RE-ARRANGE the order of sound files that are listed on a particular sound category folder; or RE-NAME a sound file. The DELETE FROM DEVICE simply provides that user can permanently delete the sound clip from the device and SHORTKEYS allows the user to view the 3-letter (or any pre-determined digit) abbreviated identifiers that have been pre-assigned to link with each of the available sound clips.

FIG. 10F shows the ADD option 1401 from the FILES menu 1400 and illustrates how a user can ADD a sound file that has already downloaded or otherwise entered into the device and stored in the device to the desired category folder on the Sound Categories interface 410. First of all, at 1410, the user needs to indicate from the three options how he wanted to view the files. “Alphabetical order” and “Chronological order” are pretty self-explanatory, which means the programmed device will display all the sound files in alphabetical order or by chronological order of the download or other entry time, respectively. In this example, the user selected to view the files by “Sound Categories.” Upon selection, at 1420, he will be prompted to choose the directory 1422 where he wants to retrieve the file. Directories are groupings, in the conventional sense, of sound files and they can be named with categorized sound effects name, in alphabetical breakdown, or in numeral grouping, etc. In this example, the user has selected “Directory #3.” Based on the user's input, a list of all the sound files 1432 from that selected directory (e.g., Directory #3) is immediately displayed for the user to select on the next interface 1430. Upon indicating the file 1432 he wants to add, the user will be prompted to select the category folder 1442 he wanted to place this specific sound file 1432 to on the Sound Categories interface 410. When this task is completed, the user will be presented a confirmation message 1450 and asked whether he wants to add another item. If not, it will take him back the MENU interface 1100. Otherwise the programmed device takes him to the ADD FILE interface 1410. It is noted that, should user indicate to add a sound file that has NOT been downloaded or otherwise stored on the device, he must download the desired file into the device first.

FIG. 10G Illustrates the DELETE FROM DEVICE option 1403 from the FILES menu 1400 and shows the steps for deleting sound files from the device (or system) permanently. In this function, at 1460, a list of all available sound clips (files that are stored on the device) is shown. Next, the user may use the numeric keypad and/or navigational tool to highlight the item he wants to delete.

By pressing the SELECT button (or, in other embodiments, a DELETE button or other appropriately named button), the programmed device will alert the user about the deletion on the next screen 1470. If he proceeds forward, it will display a confirmation message 1480 and permanently delete the file from device. On the other hand, the user may press ‘NO’ to ignore further operation and go back to the previous interface 1460. The TEMPORARY REMOVE option 1402 (diagram not shown) is similar to the DELETE FROM DEVICE function 1403. The only difference is that this function allows the user to remove a particular sound file item from the desired sound category but not from the device. With this function, user can always add the sound file back to any sound category folder because it was only removed from the Sound Categories interface, not permanently deleted from the device's memory storage. In one embodiment, both DELETE FROM DEVICE and TEMPORARY REMOVE are the same function for server-based applications, where sound clip playback is performed from the remote server.

FIG. 10H shows the REARRANGE option 1404 from the FILES menu 1400 and illustrates the process of rearranging the order of sound file items 422 to be viewed on the Sound Files interface 420. In this functionality, the user needs to indicate how he wanted to rearrange the collection of audio files at 1500. Once again, he may opt to put sound file items in alphabetical order or chronological order. Otherwise, he can manually rearrange the items. Upon choosing manual rearrangement, at 1510, the user is presented with all the sound category folders 1512 and asked to specify which folder the file is in. Based on user's selection, the next interface 1520 will display a list of all the sound files 1522 in that particular Sound Category folder. The user may select the sound file item he wanted to rearrange by either pressing the SELECT button 1312a or the corresponding numeric key then move it to the desired location with the navigational device 120.

When the desired location is reached, he needs to press the same button again (after the first press down, now RELEASE 1312b is shown) to release the item to the order of his desire. Should the user need to rearrange files from another folder he may press the STAR (*) key on this interface to take him one level up 1510 where he can choose another category folder. The button for SELECT 1312a and RELEASE 1312b acts as a multi-function button. It toggles between the SELECT 1312a and RELEASE 1312b functionality. Whenever the user is finished with rearranging the order to his liking he may press the SELECT key 1312a twice concurrently to save the changes he made and to exit this interface. Upon receiving the user's input, the device will prompt the user with a confirmation message 1530 and asked if he wants to rearrange another item (assuming there was at least one item rearranged; if no item ever been moved and rearranged before user exited the interface, it will prompted him with a slightly different message).

FIG. 10I illustrates the RENAME function 1405 from the FILES menu 1400 and shows the procedure for accomplishing same. First, at 1540, the user needs to indicate how he wants to locate the file he wanted to rename. Then, at 1550, the user will be asked to select the sound file he wanted to rename. In this example, the user has chosen to view files by ‘Alphabetical order’. Again, the user input can be performed with the numeric keypad or navigational device. Upon selection, they user now needs to enter the new name for the audio clip and the 3-letter abbreviated identifier as shown on 1555. Immediately the programmed device, in accordance with the invention, verifies the user's input 1560 to determine if user-input exceeded the pre-determined number of characters. Should user-input be inappropriate or exceed the maximum character allowance, he will be requested to re-enter 1565. Similarly, at 1562, if the inputted data matches the already existed information, the user will be prompted to enter again 1565. Otherwise, a confirmation of successful input is displayed 1570 and asks the user to indicate whether he wanted to rename another item.

FIG. 10J illustrates the SHORTKEYS option 1406 from the FILES menu 1400 and shows the process of viewing, renaming, activating, or deactivating a Short Key a coined term for abbreviated identifiers for sound files. To start, at 1580, the user needs to choose how he wanted to view the list of Short Keys: by alphabetical order, by categories, or by chronological order. In this example, it shows that user has chosen to view by Alphabetical order as shown on 1582. Upon making the selection, the user is presented with all the sound clips and their assigned abbreviated identifiers in front of each file name. If an item is in GREY 1584b, it means the abbreviated identifier is not activated yet. An activated Short Key means it is capable of recognizing such input, hence, the abbreviated identifier is actively linked to the pre-assigned sound clip. On the other hand, a deactivate Short Key implies the associated sound file will not be triggered. To activate the desired abbreviated identifier, the user needs to press the SELECT key 1586 once. If the SELECT key 1586 is pressed once more, it will de-activate the highlighted item. If an item is in BLACK 1584a, it means that particular abbreviated identifier is already activated. To de-activate it, the user presses the SELECT key 1586 once. If the user activated 1587A particular abbreviated identifier, he is prompted with a confirmation message 1588A. Should the user de-activate 1587D an item, it will display a message indicating so 1588D. User may press OK 1589Y to proceed or the UNDO button 1589N to reverse the action; in either case, the user will be transferred back to the previous interface 1582. Once again, in addition to the navigational device, the user may opt to use the numeric keypad for quick input. For instance, instead of having to navigate to a particular item before hitting the SELECT button, the user may simply press the corresponding numeric key to activate or de-activate a particular abbreviated identifier item with a fewer key strokes.

Upon making the selection, either to activate or de-activate an abbreviated identifier, the user will be prompted with a confirmation message before returning to the previous interface 1582. At this point, he can UNDO the change or select OK to transit back to the previous screen, hence the user has the option to activate, de-activate, or rename another item. If no user input is detected after two seconds, the device automatically returns to the previous screen 1582.

As shown with respect to the Short Keys function 1401 on FIG. 10J, if the user presses and holds this Right Soft Key for a predetermined time on 1582, he opts to rename the desired highlighted item. Instantly it transits 1587R him to the next screen 1590 where he can enter a new Short Key name for that particular sound file. Based on user's input and depending upon his user setting, the user's input will be checked for duplication 1592 (in this embodiment). If there's an identical Short Key name already existed, the user will be prompted to re-enter 1594. Otherwise, the screen will display a confirmation message 1596 as well as asking the user whether he wanted to perform another Short Key task. Furthermore, if the user selected to allow two or more abbreviated identifiers with the identical numeric key entry, the duplication-checking process 1592 will be skipped (not shown).

Menu Item (4), ADVANCE SETTING 1104 on the MENU interface 1100, allows the user to change the SETTINGS 1601 such as type size, color, shortcut and button functionality settings (reassign key/button functionalities), auto hide of Sound Categories interface (automatic roll up and down), graphical representations, restore default setting, etc. The user can also change the THEME 1602 of the current interface and visual layout which include, but are not limited to, styles and highlight/selection graphics and colors. SPECIAL SOUND EFFECTS function 1603 enables the user to alter his voice with possibilities including cartoon-ize, lower or raise voice pitch and tone, robot-ize, or any other voice manipulation. ADVANCE 1604 accesses advanced features such as (1) allowing the user to link certain sound files with particular key word(s) or phrase(s), hence the specific sound clip will be automatically injected to the voice path when anyone or just the caller on the phone says that particular key word(s) or phrases, (2) assigning specified sound clip call up automatically when answering the phone or when using the CALL HOLDING functionality, and (3) enabling or disabling the function of automatic volume diminishing of the playing sound clip when a speaker's voice is detected, to provide just a few examples of advanced functionality. This section could cover many more other advance functionalities and features.

Items for DOWNLOAD 1103, HELP 1105, and QUIT 1106 on the MENU interface 1100 are self-explanatory. Item (3), DOWNLOAD 1103, takes the user to the download section where he can purchase and download more sound files. Item (5), HELP 1105, takes the user to the HELP interface where he can get instructions on using the application program or about specific functionality or features including FAQ's, ability to provide feedback, and connection to a live representative for customer care issues, etc. Item (6), QUIT 1106, allows the user to terminate the program and exit the user interface.

While this invention has been described in terms of a particular embodiment, there are alterations, permutations, and equivalents that fall within the scope of this invention. It should also be noted that there are many alternative ways of implementing the methodologies (processes) and the graphical user interfaces of the present invention. It is therefore intended that the invention be interpreted as including all such alterations, permutations, and equivalents as fall within the true spirit and scope of the present invention.

Operation

In order to inject sound effects into phone conversations, a user must first download and install the sound effects and described application(s) onto his mobile phone or portable device (or purchase an apparatus with such functionality built-in). This is only required for first time user. After the application is installed, the user needs to turn the application ON (execute the software) before initialing a call or at anytime during the phone conversation.

After the application is executed, a WELCOME page is displayed (as shown on the screen on FIG. 1) in a particular embodiment using a mobile phone. When the user presses the key that is designated as the START function (e.g., the RIGHT soft key 112R), he may begin injecting sound clips into a phone conversation at anytime, assuming he already has, at least, one sound file stored on his device and that he is connected to another party on a phone conversation. If the user presses the other designated button (e.g., LEFT soft key 112L) at the WELCOME page, it takes him to the HELP interface 1800 which provides instructions and other HELP options and information.

Injecting Sound Clips by Key Entry:

To inject a sound clip with the key entry method, the user must first select a Sound Category by either pressing a STAR KEY (asterisk, *) or any pre-determined button following by the number that is corresponded to the particular sound category item. The user may perform one or two keystrokes, depending on how many items are on the interface. The user may also opt to move vertically (and/or horizontally in certain embodiments) by using the navigation device keys until the desirable sound category is highlighted (otherwise visually distinguished) then press the SELECT button, normally the RIGHT soft key to choose the highlighted sound category. Or press the numeric key which corresponds to the desired name of the Sound Category item. It is noted that, after pressing the STAR (*) key once, the Sound Categories interface is displayed on the screen until a numeric key or the SELECT button is pressed to select a sound category item.

Based on the user's selection, the Sound Categories interface will automatically disappear or roll down to hideaway (by default) and the Sound Files interface instantly displays. Each of the sound files has a corresponding number assigned to it. The user again may either use the numeric key or the navigation device (or a combination of both) to select the desired sound clip. Once it is selected, that particular sound file will be played and injected to the phone conversation. At this time, the NOW PLAYING interface with reverse-counter will be shown. At anytime while the sound clip is executed (playing), the user may press the ZERO (0) key to stop the audio file.

Should the user want to inject another sound clip, he may select another item on the list. However, should he wish to choose a sound clip from another sound category folder, he simply presses the STAR (*) button again. Instantly, the Sound Categories interface rolls up. The user now can choose another sound category with the navigation device or the numeric keypad or the combination. Upon selecting another sound category, a new set of sound clips that is associated with the selected category item will automatically and instantly be displayed for the user to pick.

Described below are some basic examples of shortcuts for allowing the user to inject sound clips or perform other functions much more quickly and easily:

To repeat the last sound file played, just press the STAR (*) key twice consecutively. To cancel or stop the current playing sound file, press the ZERO (0) key once. If the ZERO (0) key is pressed and hold for a predetermine time, it will take the user to the HELP section interface. Should the user need more information or help on a particular function or the interface he is on, all he needs to do is to press the ZERO (0) button twice consecutively. By pressing the POUND (#) key, the user indicates that he wants to randomly play (inject) a sound file from any sound category. If he presses the POUND (#) button follow by any number(s) from the numeric keypad, he indicates that he wants to randomly play (inject) a sound file from the corresponding sound category item. For example, if Sound Category item #6 is MOVIE and the user presses POUND (#) and numeral 6, any sound clip categorized as a MOVIE file will be randomly selected and played. For instance, it could be Forest Gump's “Life's like box of chocolate . . . ” or Terminator's famous clip “I will be back.” For more examples of shortcuts and button functionalities, please refer to FIG. 9.

Injecting Sound Clips with Abbreviated Identifiers:

Each sound clip has a pre-assigned abbreviated identifier (also refer to as 3-key I.D. and Short Key I.D.). It is intended to be three characters for representation, but not restricted to the first three letters of the sound clip name and subject to change, for example by designating four or even five letters or other keystrokes for the abbreviated identifier function. When user presses three numeric keys consecutively, the sound clip that is associated with that particular abbreviated identifier will be automatic played and injected into phone conversation.

For example, if the 3-key I.D. for the Happy Birthday jingle is B-I-R and when user presses 2-4-7 consecutively, the Happy Birthday clip will be played. Another example, if the abbreviated identifier for a sound clip from Scary Movie is “W-A-S”, when the user presses 9-2-2, the “Wassup” sound file will be played and injected. If there are two or more 3-key ID's having identical numeric-key entry, then upon user input of the 3-key I.D., the user will be presented with a list of sound clips that have the exact same numeric keys equivalence for further user selection. For instance, in one embodiment, if the user presses 2-2-2, the display will present two sound clips for further user selection. Because the user has one sound file of “Taxi cab” that spells C-A-B for its 3-key I.D. and another clip that with 3-key I.D. of B-A-C for the Terminator's famous “I will back” line. By default, duplicated abbreviated identifiers are not allowed. However, user may change the user preference setting to override this functionality, hence, to allow greater 3-key I.D. combination possibilities and identical numeric key entries.

Abbreviated identifiers may be assigned anyway that are easy to remember and recall. The same Happy Birthday clip may have pre-programmed 3-key I.D., e.g., H-A-P or H-B-D. These 3-key IDs can be customized or reassigned by the user. Abbreviated identifier is not restricted to only a three-digit input, for example, it could be 4 or even 5 digits long or in any predetermined length.

Alternatively to the use of a multi-key identifier or code, a single key identifier may be pre-assigned or programmed to select and inject a particular sound file. The sound file is pre-assigned to the key. The key may be operated by pressing and holding, in the manner of conventional “speed key” dialing, to activate the programmed feature, in this case the injection of the associated sound file into the conversation.

Injecting Sound Clips with Speech Recognition:

Injecting sound clips with this methodology is quick and simple, because it can be performed in two fast and easy steps. All the user need do is to press and hold the predetermined button on the phone and speak the keyword or phrase for the sound file he desires, then release the button when finished with the verbal input. The sound clip that is pre-assigned with particular speech input will be played and injected into the phone conversation automatically and instantly. If no such sound clip exists, no action will be performed or the user may simply informed that he didn't have that particular sound clip. The predetermined button can be a STAR (*) key, POUND (#) key, a special button created by phone manufactures, or any key pre-assigned by the phone company.

In one embodiment, user may press and hold the POUND (#) key and say either “Happy Birthday” or “Birthday,” then the happy birthday song will be played instantly upon releasing the POUND (#) key. Another example, the user may verbalize “What's up doc” or “Bugs Bunny” to trigger and inject the famous Bugs Bunny's ‘What's up doc’ line.

The user may view, edit, and/or customize all keywords or phrases that are associated with each specific sound effects file. For instance, one user may also include “Happy” as the keyword for the Happy Birthday sound clip.

Automatic Injection of Sound Clips:

In accordance with one embodiment of the invention, sound clips can be played (injected) automatically based on (1) chatters' tone and mood of voices, and (2) keyword(s) and phrase(s) in chatters' conversation. The user must configure such settings in advance. For example, if the user has assigned the key word/phrase “HUNGRY” and “Where do we want to eat?” With McDonald's “I am Lovin' It” commercial jingle. At anytime during the conversation, should anyone on the phone say the keyword “HUNGRY” or phrase “Where do we want to eat,” immediately and automatically, the McDonald's jingle will be played and injected into the phone conversation. Another example, should the user have linked the key phrase “Tell me” to the “You can't handle the truth” sound clip, whenever someone says “tell me” in any part of the sentence and conversation, then this audio file is triggered.

In another embodiment, automatic sound clip activation and injections can be linked to a caller's I.D., which means when someone calls the user the sound clip he has pre-assigned to the caller's phone number will be automatically played and injected to the voice path when user answers the call. For instance, if the user has configured to link Bugs Bunny's “What's up doc?” to Michelle and Jack's phone numbers and linked a clip of Lionel Richie' great hit to his girlfriend's caller ID; then whenever Jack or Michelle calls, Bug Bunny's famous line will be played when the user answers the phone but it will play and inject Lionel Richie' “Hello . . . is it me you're looking for . . . ” song clip when he answers his girlfriend's phone call. In another embodiment of automatic sound file injection: the user may preset Arnold Schwarzenegger's “I will be back . . . ” to the HOLD functionality, and whenever he presses the HOLD function/button on the phone to pick up another incoming call, the famous Terminator movie clip will be played and it's audible for the person who is on hold.

With the speech recognition methodology of this invention, sound files may or may not reside at the client-side device; consequently remote access of audio files from central server(s) could be an alternative embodiment.

### Alternative Embodiments

While the invention has been shown and described with respect to particular embodiments, the reader will appreciate that numerous alternatives are possible. For example:
In addition to mobile phones, the graphical user interface and methodologies described herein would also work on different type of devices or mechanisms that is capable of audio playback, including, but not limited to PDA's, pocket PCs, smart phones, land-wired telephones, notebook computers, Multimedia players, MP3 players, desktop computer as well as any operating system or platform such as J2ME, Symbian, Windows Mobile, Qualcomm's BREW, etc.
The dimensions of the device's display screen and the number of pixels and lines of text varied with different embodiments. The display could be in color or monochrome.
The functions for the pre-assigned keys such as the SOFT (selection) key, STAR (*) key, and Pound (#) button, among other buttons described herein, may be interchangeable and different buttons/keys or input tools on different embodiments.
In addition to English, user interfaces and speech recognition as well as all sound clips can be in other languages.
Menus and other user-selectable items can be presented as an icon or other graphical representation and not limited to the listing format illustrated herein.
Interfaces and its items and the arrangement can be customized based on user's preferences and are not restricted to the examples and order described herein.
Users may purchase and download new sound clips directly from their mobile phone, land-wired telephone, computers, and any other method for file transfer.
With permission from users, promotional sound clips (such as free audio files or clips from our advertiser partners) may be sent to their devices or emails directly.
Users may modify and/or customize the user interface and application program settings from their phones, computers, PDA's, etc.
Interface transition may be drive-in, flying, wide, fade, split, roll-down, etc.
Interfaces and prompts as well as MENU options may be different described herein and they be modified based on the platform or system executed on.
Typefaces, colors, and size as well as selection indicators can be personalized or can be chosen from one of the theme settings.
Navigation and item selection can be performed with key entry, scrolling wheel, navigational stick or ball, touch pad, voice command, etc. or combination.
Media assets (sound clips) can be stored in the portable device and/or in central system storage for remote retrieval of the audio files.
Key digits for abbreviated identifiers could be 2, 3, 4, or any length and they can be customized, activated, deactivated, rename, etc.
Abbreviated identifier function may work with the Sound Category interface for more combination possibilities which means user needs to select the desired sound category before pressing the 3-key abbreviated identifier that is associated with the particular sound clip and duplicated abbreviated identifiers on different sound category folders are allowed.
   Summary

In summary, there are provided numerous methods, systems and apparatus enabling users to quickly and easily inject audio sound effects into electronic communications. In various embodiments, the described invention may include the following.

Unique methods for assisting user to play and inject sound effects to phone conversations quickly and easily using a portable device and the alike, comprising:
a. Using a numeric keypad or user input device or the combination to trigger a particular sound clip;
b. Using speech recognition tool to trigger a particular sound clip; and
c. Using abbreviated identifiers that are assigned to each of the sound files to trigger a particular sound clip.

Methods as above wherein a portable device takes the form of a mobile phone, land-wired telephone, cordless phone, PDA, handheld computer, PC, notebook PC, radio, or other multimedia asset device such as DVD player and MP3 player, and the alike.

Methods as above wherein a numeric keypad can take forms of an ITU-T standard telephone keypad, one-row keyboard, or other contrivances.

Methods as above wherein the speech recognition tool is a technology that enables an apparatus to understand the spoken word; hence, apparatus interprets audible input from a user and converts this data into a usable form and command.

Methods as above wherein the speech recognition tool may reside on the device and/or on the remote system server; it can be in any language and it may be any third party software deemed appropriate.

Methods as above wherein abbreviated identifiers are pre-assigned 3-letter groupings and each of the groupings is linked to a specific sound clip.

Methods as above wherein a user input device can take a variety of forms, such as a manually operated switch, button, keypad, navigational device, touch pad, dial, wheel, or other such contrivances.

Methods as above wherein a sound clip and sound file can be MP3 files, AAC-Plus, or any other properly formatted CODEC files and they can be stored on the portable device and/or remote system server.

Methods as above wherein injecting sound effects to phone conversation simply means sound clip is transited to the voice path where it is audible to all parties on the phone conversation, including the user.

Methods as above wherein the voice path is a mechanism where voice and audio signal are transited to the caller's phone speaker and the phone of the person or persons on the other line of the conversation.

Methods as above wherein using the keypad or speech recognition tool to trigger a particular sound clip is a quick and easy two-step method while using abbreviated identifiers to trigger a particular sound clip is a fast one-step method.

A process of using a numeric keypad or user input device or the combination to inject sound effects to phone conversations with a portable device and the alike by way of a hierarchically ordered user interface, comprising the steps of:
displaying a first order interface having a list of user-selectable sound category items and corresponding item number;
receiving a user input of one of the first order interface items using the numeric keypad;
or highlighting a desired one of the listed items and receiving a selection of the highlighted item;
automatically transitioning to and instantly displaying a second order interface based upon the user selection;
receiving a user input of one of the second order interface items using the numeric keypad; or highlighting a desired one of the listed items and receiving a selection of the highlighted item; and
the selected item will automatically and instantly triggered and injected to the voice path where it's audible to all parties on the phone conversation thereof displaying the third order interface showing the selected item is playing along with any other data.

Methods as above wherein are provided a quick and easily two-step process: first selecting a sound category and then selecting the desired sound clip to be played and injected.

Methods as above wherein, generally, a specific sound clip within a particular sound category of choice can be triggered with only three keystrokes and only one or two keystrokes to select another clip within the same category with the method.

Methods as above wherein the first order interface also refer to as Sound Categories interface and second order interface also refer to as Sound Files interface.

Methods as above user-selectable items can be presented as an icon or other graphical representation and not limited to the listing format illustrated herein.

Methods as above wherein user navigation, input, and selection can be performed using a keypad or a user input device or the combination.

Methods as above wherein highlighting can be substituted with various elements, such as bolded typeface, color change, or otherwise visually distinguished.

Methods as above wherein the second order interface is a proper subset of the first order interface and it includes a collection of user selectable sound file items that is associated with the selected category item on the first order interface.

Methods as above wherein, in addition to using the user input device, user may trigger a particular sound clip by pressing a numeric key or keys which corresponds the desired item.

Methods as above wherein if the list of sound file is lengthy, user can press and hold one of the number keys, 2 to 9, to locate a sound file beginning with the first letter on that key or closest following; Press the same key again to jump to the next letter, and eventually it will loop back to the first letter of that particular key when the last letter is reached.

Methods as above further comprising: user selectable item on the first order interface is a folder or folders containing more other user-selectable items.

Methods as above wherein if an first order interface item contains more than one subset of user selectable items, the Sound Files interface is pushed one or more addition level down where Sound Files interface may be the third, fourth, or even fifth order interface.

Methods as above wherein, based on user preference setting, the second order user interface could be displayed on the same screen with the first order interface as one is stacking on top of the other.

Methods as above wherein the hierarchically order interfaces may contain any number of user-selectable items and any number of level of interfaces.

Methods as above wherein the first order interface of user selectable items includes a folder item, a B folder item, a C folder item, a D folder item, and so on, where each folder is a user customizable item.

Methods as above wherein when the selected item is the A folder item, then the list of user selectable items on the second order interface includes a list of sound clips that is associated with the A folder, when the selected item is the B folder item, then the list of user selectable items on the second order interface includes a list of sound clips that is associated with the B folder, when the selected item is the C folder item, then the list of user selectable items on the second order interface includes a list of sound clips that is associated with the C folder, and so on.

Methods as above wherein the voice path is a mechanism where voice and audio signal are transited to the caller's phone speaker and the phone of the person or persons on the other line of the conversation.

Methods as above wherein pressing a designated button, for example, pressing the STAR (*) key will cause first order interface to actuated and automatic displayed on the screen awaiting for further user input.

Methods as above wherein immediately pressing a number corresponding to one of the user-selectable category items upon pressing the STAR (*) key will result an automatic transitioned to and instant displayed of the second order interface where a list of user selectable items that is associated with the selected category item is presented.

Methods as above wherein choosing a sound category item from the first order interface, user may opt to use the numeric keypad or navigational device or the combination of user input devices.

Methods as above wherein the repeat audio playback function is triggered by pressing a designated button, for example, pressing the STAR (*) key twice consecutively, in turn the last played audio file will be played again.

Methods as above wherein pressing a designated button, for example, pressing the ZERO (0) key once will stop or cancel the sound file from playing.

Methods as above wherein pressing a designated button, for example, pressing the ZERO (0) key consecutively will result an automatic transitioned to and instant displayed help information and/or instruction on the current page or functionality.

Methods as above wherein pressing a designated button, for example, pressing and holding the ZERO (0) key will result an automatic transitioned to and instant displayed the HELP interface where more help options are available for user selection.

Methods as above wherein pressing a designated button, for example, pressing the POUND (#) key once will cause first order interface to actuated and automatically displayed on the screen; however if no further input by the user at a predetermine time, it automatically and randomly inject one of the available sound clip from any sound category to the phone conversation.

Methods as above wherein immediately pressing a number corresponding to one of the user-selectable category items upon pressing the POUND (#) key will result an automatic and random injection of an available sound clip from the selected corresponding sound category to the phone conversation.

Methods as above wherein choosing a sound category item from the first order interface, user may opt to use the keypad or user navigational keys or the combination of user input devices.

In a portable device, a hierarchically ordered graphical user interface accessible to a user suitable for receiving user supplied inputs that facilitate selecting and injecting a sound clip to phone conversations, comprising:
a first order interface having an index or list of user selectable folder items;
a user activated the numeric keypad or user input device suitable for selecting at least one of the user selectable items on the first order interface;
a second order interface having a list of user selectable file items based upon the selected item of the first order interface; and
a user activated the numeric keypad or user input device suitable for selecting at least one of user selectable items on the second order interface, wherein when the user selects at least one of the user selectable items, the first order interface automatically transitions to the second order interface.

Devices as above wherein when the selected item on the first order interface is the A folder item, then the second interface is an index or a list that includes at least one selectable sound clip associated with the A folder, wherein when the selected item on the first order interface is the B folder item, then the second interface is an index that includes at least one selectable sound clip associated with the B folder, wherein when the selected item on the first order interface is the C folder item, then the second interface is an index that includes at least one selectable sound clip associated with the C folder, and so on.

Devices as above wherein when the selected item on the second order interface is activated, then automatically transition to the NOW PLAYING interface where it shows the selected item is playing along with any other data or information deemed appropriate.

A method of using a speech recognition tool to inject sound effects to phone conversations with a phone and the alike, comprising the steps of:
activating the speech recognition function by pressing and holding the designated button, e.g., the POUND (#) key;
speaking the designated keyword or phrase or name that is linked to the desired sound clip;
releasing the depressed designated button; and
the desired sound clip will automatically and instantly play and inject to the voice path where it's audible to all parties on the phone conversation.

Methods as above wherein they can be summarized as a fast simple two-step process: first pressing a button and then speak to the microphone.

Methods as above wherein the designated button can be the POUND (#) key or any other predetermined button or user input device.

Methods as above wherein the keyword or phrase is customizable by the user and may be one or more syllable.

Methods as above wherein the speech recognition tool may reside on the device and/or on the remote system server.

Methods as above wherein if the spoken key word or phrase is not identified, not understandable, or not associated with any available sound clip, then nothing will happen or the system or device will inform the user of such response.

A process of using abbreviated identifier entries to inject sound effects to phone conversations with a portable device and the alike, comprising:
entering one of the pre-assigned 3-key abbreviated identifiers that is associated with a specific sound clip using the keypad; and
the sound clip that is associated with selected 3-key input will automatically and instantly play and inject to the voice path where it's audible to all parties on the phone conversation.

Methods as above wherein they can be summarized as a fast convenient one-step process and may be incorporated with the Key Entry method described herein.

Methods as above further comprising: should there be more than one match of the numeric key input from the user a list of sound clips with abbreviated identifiers that have the same match of the three numeric key entry is displayed for further user selection.

Methods as above further comprising the step of selecting a sound clip on the list.

Methods as above wherein selecting one of the user selectable sound file items on the list using the numeric keypad and/or user input device; and upon selecting the desired sound clip, an automatic transitioned to the NOW PLAYING interface where it shows the selected item is playing along with any other data or information deemed appropriate.

Methods as above wherein abbreviated identifiers are pre-assigned 3-letter groupings and each of the groupings is associated with a specific sound clip or a group of sound clips.

Methods as in above wherein abbreviated identifiers are user customizable and can any number of letters (digits).

Methods as above wherein pressing three numeric keys consecutively that is corresponding to the pre-assigned abbreviated identifiers of a particular sound clip will result an instant and automatic playing and injecting of that particular sound clip.

Methods as above further comprising: in an alternative embodiment, pressing a designated button will cause first order interface to actuate and automatic displayed on the screen waiting for further user input.

Methods as above wherein immediately pressing a number corresponding to one of the user-selectable category items upon pressing the designated button enables restriction of user input of the abbreviated identifier to be within only the selected sound category item.

Methods as above wherein immediate input of the 3-key abbreviated identifier is needed to trigger the desired sound clip within the selected sound category.

Methods as above wherein simply mean an identical abbreviated identifier from another sound category will not be triggered.

Methods as above further comprising advance features such as AUTOMATIC INJECTION of sound clips to phone conversations are available in a specific or all of the methods described herein.

Methods as above wherein a particular pre-assigned sound clip is automatically and instantly injected to the voice path when certain button or function on the portable device is depressed or triggered.

Methods as above wherein the button and function can be any pre-determine keys or functionality such as, e.g., the HOLD, busy signal, and phone pick up functions.

Methods as above wherein a particular pre-assigned sound clip is automatically and instantly injected to the voice path when a predetermined keyword or phrase that is linked to that particular sound file is detected during the phone conversation.

Methods as above wherein the keyword or phrase is customizable by the user and may be one or more syllable.

Methods as above wherein a particular pre-assigned sound clip is automatically and instantly injected to the voice path when certain tone or mood of user's voice is detected during the phone conversation.

Methods as above wherein moods and tones are customizable by the user and may link to particular mood and/or tone to any particular file or files.

Methods as above further including automatic and random injections of any sound clip at anytime and/or at a predetermine time after a sound clip is triggered.

Methods as above further including automatic injections of promotion sound clips or advertising messages from partner advertisers.

Methods as above wherein a graphical user interface is produced by an application program or embedded software.

Methods as above wherein said user interface includes at least: a first order interface showing a list of sound category items, with at least one of the sound category items being capable of being selected by the user; a second order interface showing a list of sound file items, with at least one of the sound file items being capable of being selected by the user, and so on.

Methods as above including a MENU and sub-menus interface providing options for interface and sound file customization as well as management by user; further comprising: allowing user to add, delete, rename, and rearrange sound category and sound file items on the interface.

Methods as above further including functionalities such as, e.g., interface theme customization, user preferences and setting modification, downloading sound clips, instructions, HELP information, feedback input, etc.

Methods as above wherein all methodologies described herein can be functioned separately on different products and applications, or they can be integrated to products and services in any of the combination using the methods described herein.

It will be apparent to those skilled in the art that numerous improvements, changes and modifications may be made in the embodiments illustrated, without departing from the spirit and the scope of the invention.

What is claimed is:

1. An apparatus, comprising:
a device for establishing an audible communication between a human device user and a human listener;
a plurality of sound categories stored on the device, each sound category for one or more of a group of related audio sounds;
a plurality of sound files stored on the device, each of the sound files containing an audio sound, each of the sound files associated with at least one of the plurality of sound categories; and
a user interface operable by the human device user to select any one of the plurality of sound files from any one of the plurality of sound categories using two or less user inputs whereby the audio sound of the selected one of the plurality of sound files is injected into the audible communication.

2. The apparatus of claim 1 wherein the user interface is selected from the group comprising a manual input device, a manual input device and display in combination, and a speech recognition tool.

3. The apparatus of claim 2 wherein the user interface is the manual input device and display in combination and the two or less user inputs comprises:
a first input to the manual input device to select a sound category from a list of sound categories displayed on the display whereby to display a list of sound files associated with the selected sound category; and
a second input to the manual input device to select a sound file from the displayed list of sound files.

4. The apparatus of claim 2 wherein the user interface is the manual input device and wherein the two or less user inputs comprises a single user input of an identifier into the manual input device.

5. The apparatus of claim 2 wherein the user interface is the speech recognition tool and the two or less user inputs comprise a speech input into the device.

6. The apparatus of claim 1 wherein the device is selected from the group comprising a mobile phone, a land-wired telephone, a cordless phone, a PDA, a handheld computer, a PC, a notebook PC, a radio, and a multimedia asset device.

7. The apparatus of claim 2 wherein the user input device is selected from the group comprising a switch, a button, a keypad, a navigational device, a touch pad, a dial, and a wheel.

8. The apparatus of claim 1 wherein the device is a mobile telephone and the audio sound of the selected audio file is injected into a mobile telephone communication and audible to both the human device user and the human listener.

9. The apparatus of claim 1 wherein the user interface is further operable to receive user input for editing the plurality of sound categories and user input for editing the plurality of sound files.

10. A communication device for injecting a sound clip into a conversation, comprising:
the communication device including a graphical display, the communication device for establishing a conversation between first and second users;
a selectively displayable list of a plurality of sound categories each describing a group of related sounds;
a list of sound files associated with each of the plurality of sound categories automatically displayed upon the selection of one of the plurality of sound categories; and
a user interface operable by a device user to select at least one of the list of sound categories and at least one of the list of sound files whereby to inject the at least one of the list of sound files into the conversation.

11. The communication device of claim 10 wherein the user interface is selected from the group comprising a manual input device, a manual input device and display in combination, and a speech recognition tool.

12. The communication device of claim 11 wherein the user interface is the manual input device and display in combination operable to receive:
a first input to the manual input device to select a sound category from a list of sound categories displayed on the display whereby to display a list of sound files associated with the selected sound category; and
a second input to the manual input device to select a sound file from the list of sound files.

13. The communication device of claim 11 wherein the user interface is the manual input device operable to receive a single user input of an identifier into the manual input device.

14. The communication device of claim 11 wherein the user interface is the speech recognition tool operable to receive a speech input.

15. The communication device of claim 10 wherein the communication device is selected from the group comprising a mobile phone, a land-wired telephone, a cordless phone, a PDA, a handheld computer, a PC, a notebook PC, a radio, and a multimedia asset device.

16. The communication device of claim 11 wherein the user input device he is selected from the group comprising a switch, a button, a keypad, a navigational device, a touch pad, a dial, and a wheel.

17. The communication device of claim 10 wherein the communication device is a mobile telephone and the audio sound of the selected audio file is injected into a mobile telephone communication and audible to both the human device user and the human listener.

18. The communication device of claim 10 wherein the user interface is further operable to receive user input for editing the plurality of sound categories and user input for editing the plurality of sound files.

19. A method for injecting audio sounds into a human conversation on a communication device, the communication device including a graphical display and a user interface operable to receive device control signals from a device user, the method comprising:
providing a selectively displayable list of a plurality of sound categories each describing a group of related sounds;
providing, associated with each of the plurality of sound categories, a list of sound files automatically displayed upon the selection of a corresponding sound category; and
receiving from the user interface at least one of, a sequential selection from first the list of sound categories and next the automatically displayed list of sound files, and a direct selection of one of the list of sound files, whereby to inject a selected sound file into the human conversation.

20. The method of claim 19 and further including the step of automatically selecting a sound file based upon at least one of the group comprising the characteristics of a speaker's voice, the content of a speaker's statement and the identification of an incoming communication.
